(19) United States
(12) Patent Application Publication
(10) Pub. No.: US 2002/0133593 A1
(43) Pub. Date: Sep. 19, 2002

(54) Systems and methods for the deterministic management of information

(76) Inventors: Scott C. Johnson, Round Rock, TX (US); Mark J. Conrad, Colorado Springs, CO (US); Roger K. Richter, Leander, TX (US)

Correspondence Address: RICHARD D. EGAN, O'KEEFE, EGAN & PETERMAN, L.L.P., Building C, Suite 200, 1101 Capital of Texas Highway South, Austin, TX, 78746, US

(21) Appl. No.: 09/797,200

(22) Filed: Mar. 1, 2001

Related U.S. Application Data
(60) Provisional application No. 60/246,401, filed on Nov. 7, 2000.
(60) Provisional application No. 60/187,211, filed on Mar. 3, 2000.

(51) Int. Cl. G06F 15/173

(52) U.S. Cl. 709/226; 709/241

(57) ABSTRACT

A method and system for the deterministic management of information that may be employed, for example, to deliver content or services in a network environment. The method may include identifying and verifying the availability of system resources required to process a request for content or services before accepting the request. The available required resources may be reserved in conjunction with accepting a request to ensure that the request is efficiently processed. The system may be divided into a plurality of monitored and distributively interconnected subsystems, each interacting with the others in a deterministic manner so as to allow a system monitor to oversee and manage resource availability and increase efficiency of processing the request.

This application claims priority from Provisional Application Serial No. 60/246,401 filed on Nov. 7, 2000 which is entitled “SYSTEMS AND METHODS FOR THE DETERMINISTIC MANAGEMENT OF INFORMATION” and to Provisional Application Serial No. 60/187,211 filed on Mar. 3, 2000 which is entitled “SYSTEM AND APPARATUS FOR INCREASING FILE SERVER BANDWIDTH,” the disclosures of each being incorporated herein by reference.

### BACKGROUND OF THE INVENTION

The present invention relates generally to computing systems, and more particularly to network connected computing systems.

Most network computing systems, including servers and switches, are typically provided with a number of subsystems that interact to accomplish the designated task/s of the individual computing system. Each subsystem within such a network computing system is typically provided with a number of resources that it utilizes to carry out its function. In operation, one or more of these resources may become a bottleneck as load on the computing system increases, ultimately resulting in degradation of client connection quality, or severance of one or more client connections.

Network computing system bottlenecks have traditionally been dealt with by throwing more resources at the problem. For example, when performance degradation is encountered, more memory, a faster CPU (central processing unit), multiple CPU's, or more disk drives are added to the server in an attempt to alleviate the bottlenecks. Such solutions therefore typically involve spending more money to add more hardware. Besides being expensive and time consuming, the addition of hardware often only serves to push the bottleneck to a different subsystem or resource.

### SUMMARY OF THE INVENTION

Disclosed herein are systems and methods for the deterministic management of information, such as management of the delivery of content across a network that utilizes computing systems such as servers, switches and/or routers. Among the many advantages provided by the disclosed systems and methods are increased performance and improved predictability of such computing systems in the performance of designated tasks across a wide range of loads. Examples include greater predictability in the capability of a network server, switch or router to process and manage information such as content requests, and acceleration in the delivery of information across a network utilizing such computing systems.

The disclosed systems and methods may be advantageously employed to solve unpredictability, delivery latencies, capacity planning, and other problems associated with general application serving in a computer network environment, for example, in the delivery of streaming media, data and/or services. Other advantages and benefits possible with implementation of the disclosed systems and methods include maximization of hardware resource use for delivery of content while at the same time allowing minimization of the need to add expensive hardware to a content delivery system, and elimination of the need for an application to have intimate knowledge of the hardware it intends to employ by maintaining such knowledge in the operating system of a deterministically enabled computing component.

In one exemplary embodiment, the disclosed systems and methods may be employed with network content delivery systems to manage content delivery hardware in a manner to achieve efficient and predictable delivery of content. In another exemplary embodiment, deterministic delivery of data through a content delivery system may be implemented with end-to-end consideration of QoS priority policies between components. In yet another exemplary embodiment, delivery of content may be tied to the rate at which the content is delivered from networking components. These and other benefits of the disclosed methods and systems may be achieved, for example, by incorporating intelligence into individual system components.

### BRIEF DESCRIPTION OF THE DRAWINGS

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C is a simplified schematic diagram showing one possible network content delivery system hardware configuration.

FIG. 1D is a simplified schematic diagram showing a network content delivery engine configuration possible with the network content delivery system hardware configuration of FIG. 1C.

FIG. 1E is a simplified schematic diagram showing an alternate network content delivery engine configuration possible with the network content delivery system hardware configuration of FIG. 1C.

FIG. 1F is a simplified schematic diagram showing another alternate network content delivery engine configuration possible with the network content delivery system hardware configuration of FIG. 1C.

FIGS. 1G-1J illustrate exemplary clusters of network content delivery systems.

FIG. 2 is a simplified schematic diagram showing another possible network content delivery system configuration.

FIG. 2A is a simplified schematic diagram showing a network endpoint computing system.

FIG. 2B is a simplified schematic diagram showing a network endpoint computing system.

FIG. 3 is a functional block diagram of an exemplary network processor.

FIG. 4 is a functional block diagram of an exemplary interface between a switch fabric and a processor.

FIG. 5 is a flow chart illustrating a method for the deterministic delivery of content according to one embodiment of the present invention.

FIG. 6 is a simplified schematic diagram illustrating a data center operable to perform deterministic delivery of content according to one embodiment of the present invention.

### DESCRIPTION OF ILLUSTRATIVE EMBODIMENTS

Disclosed herein are systems and methods for operating network connected computing systems. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the present invention are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clients via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multi-processor system configured in a staged pipeline manner.

### EXEMPLARY SYSTEM OVERVIEW

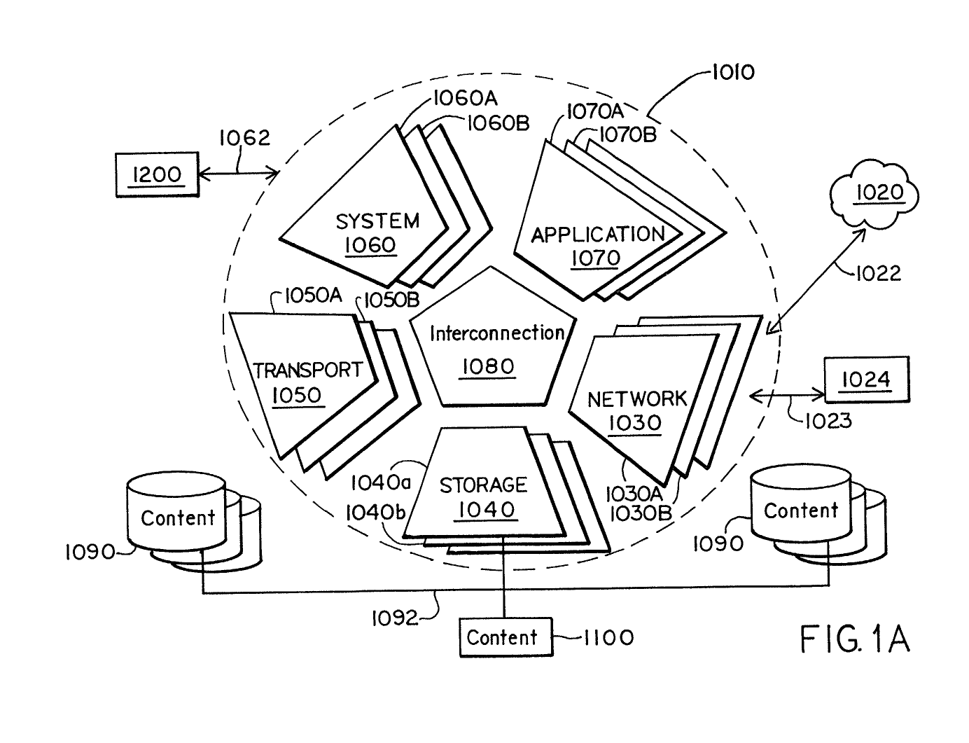

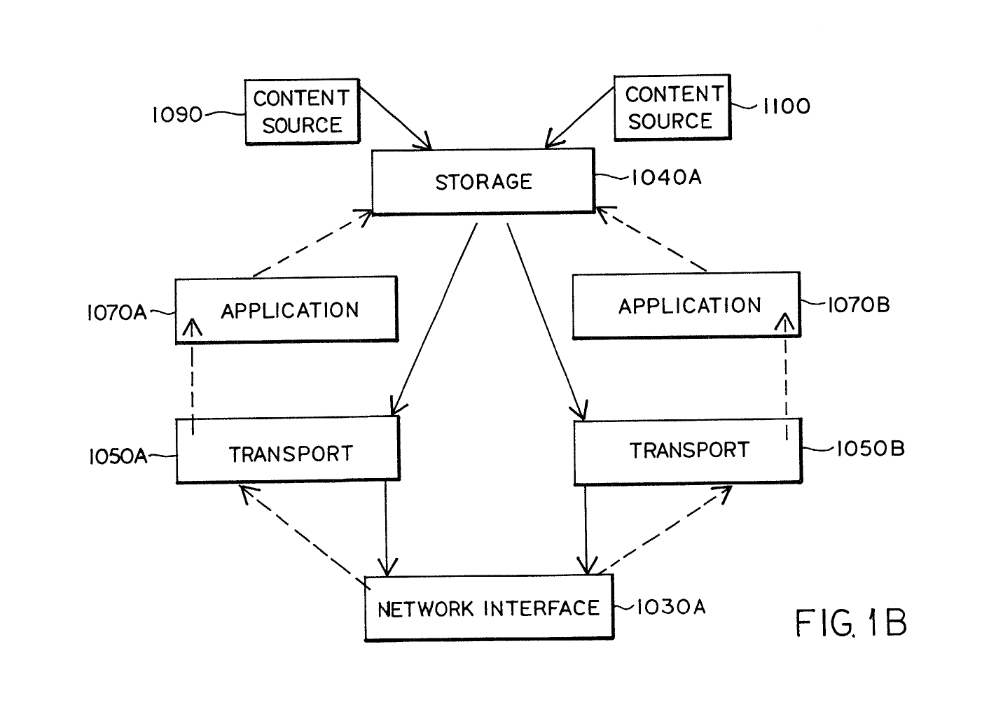

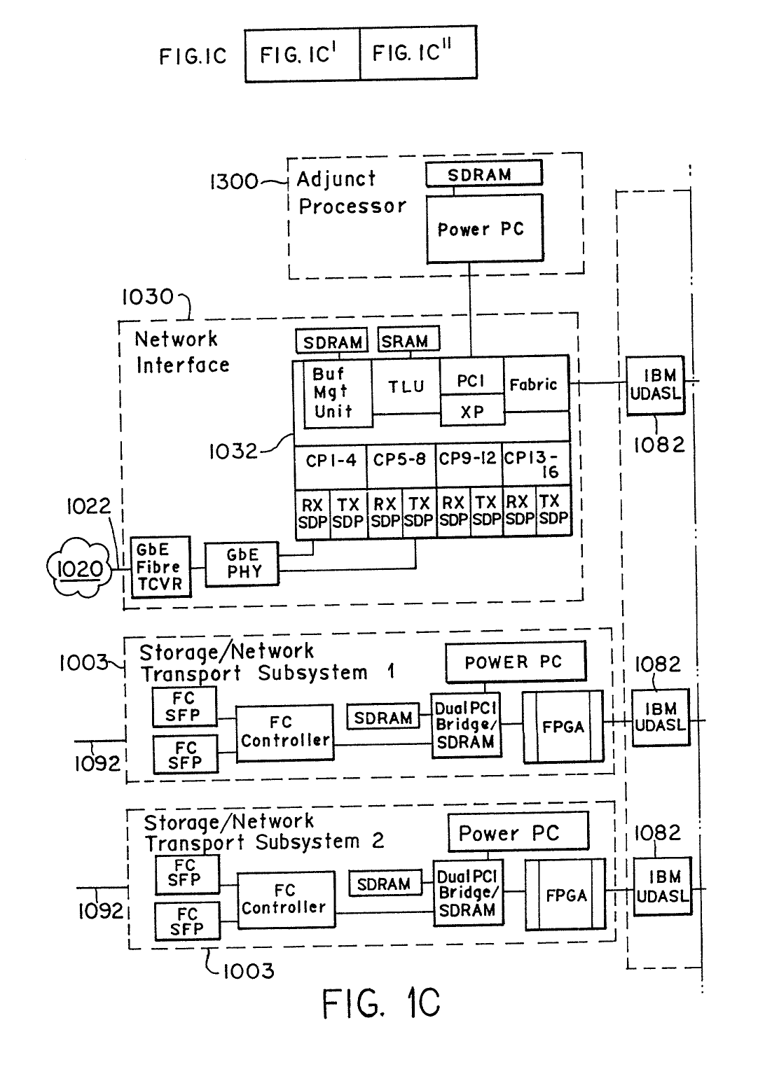

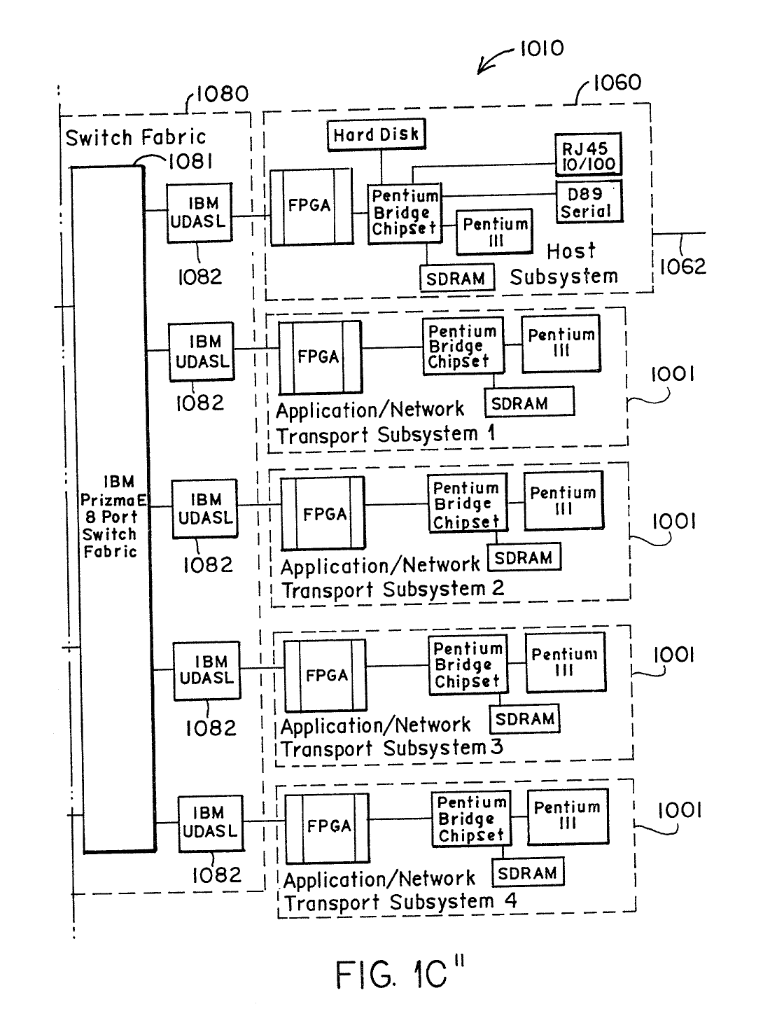

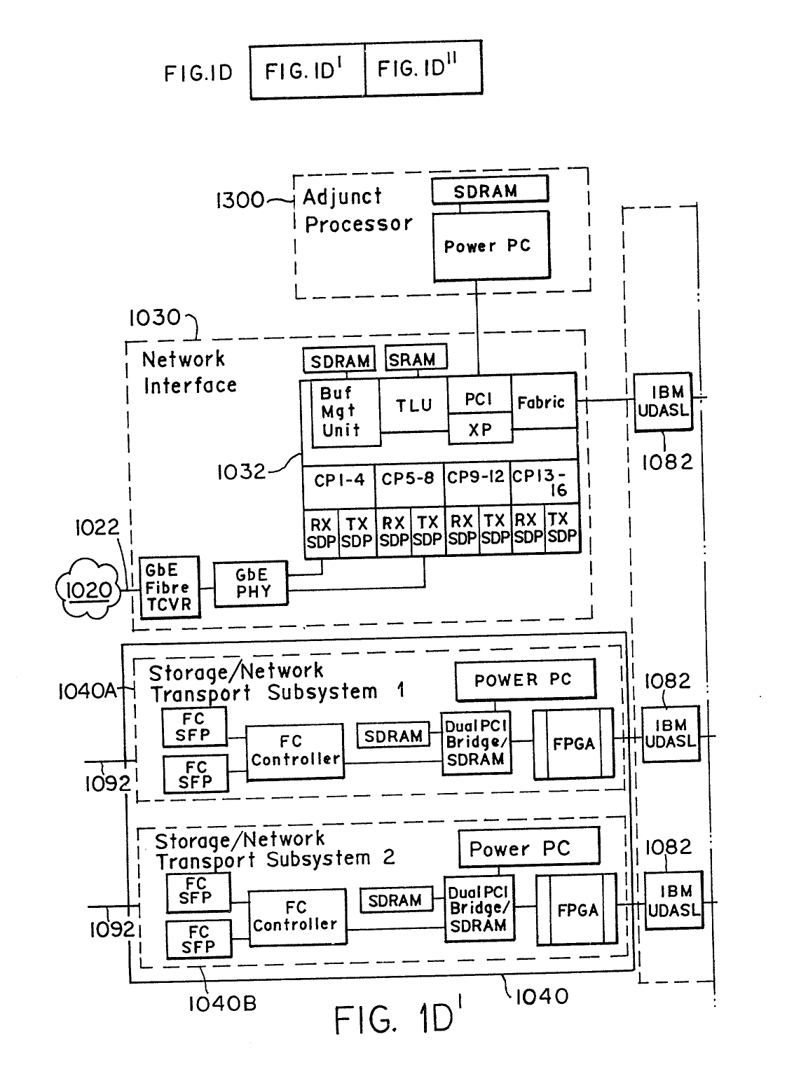

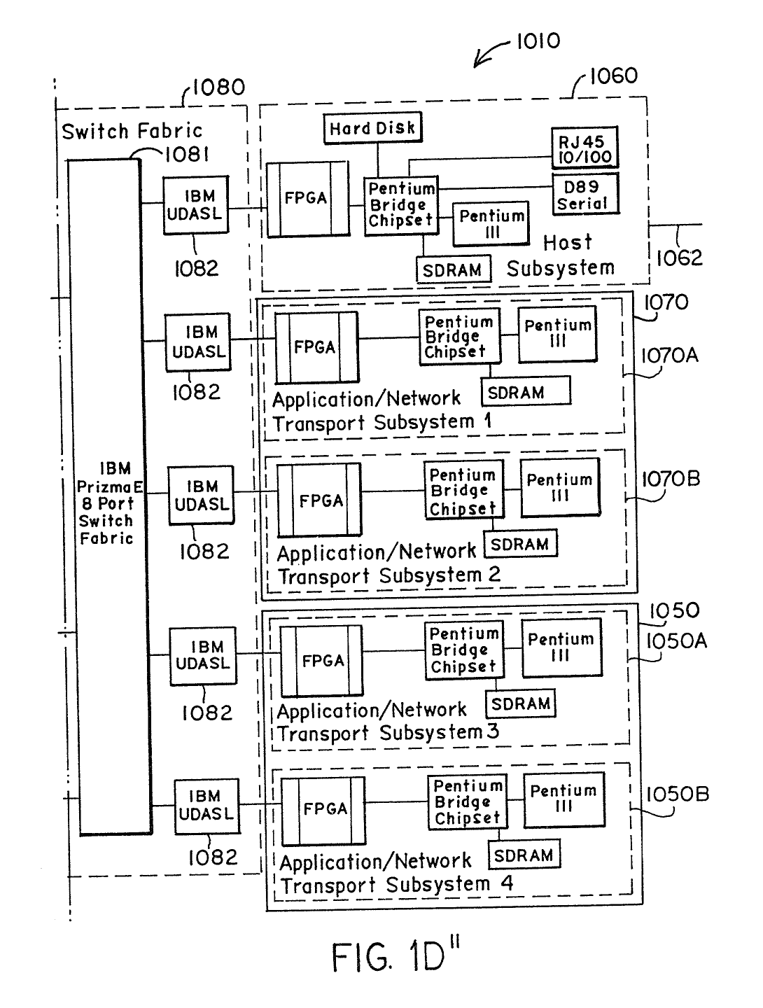

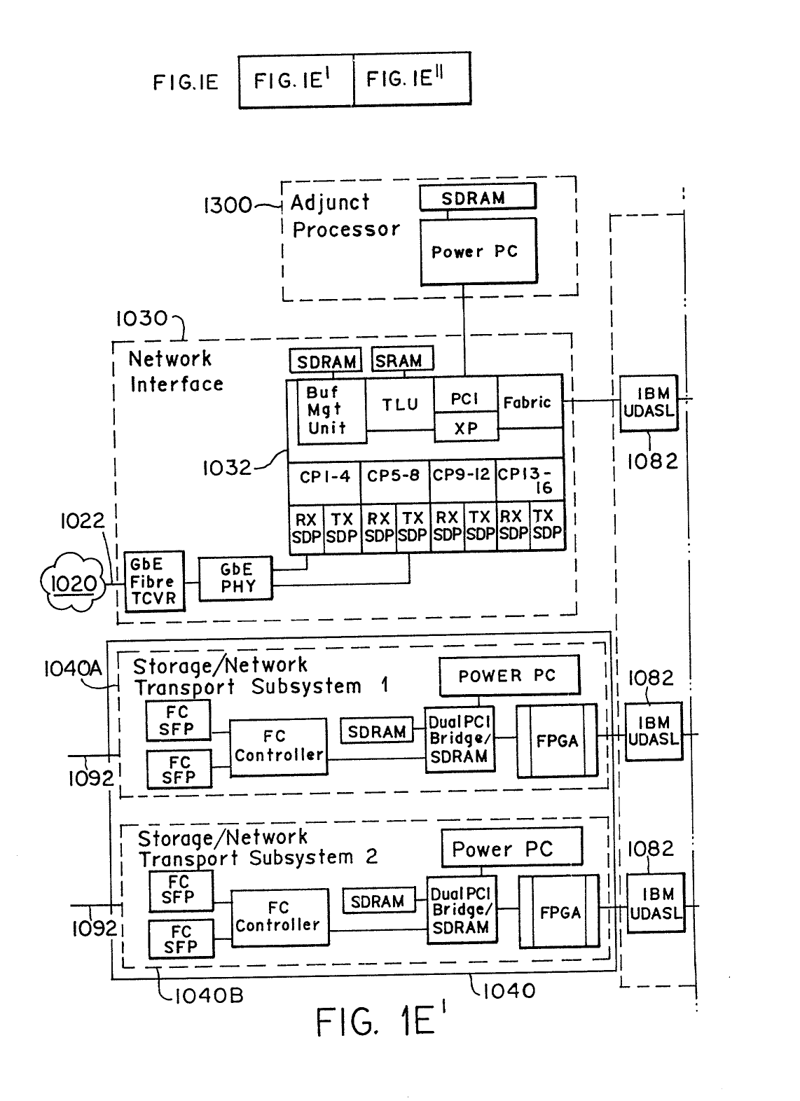

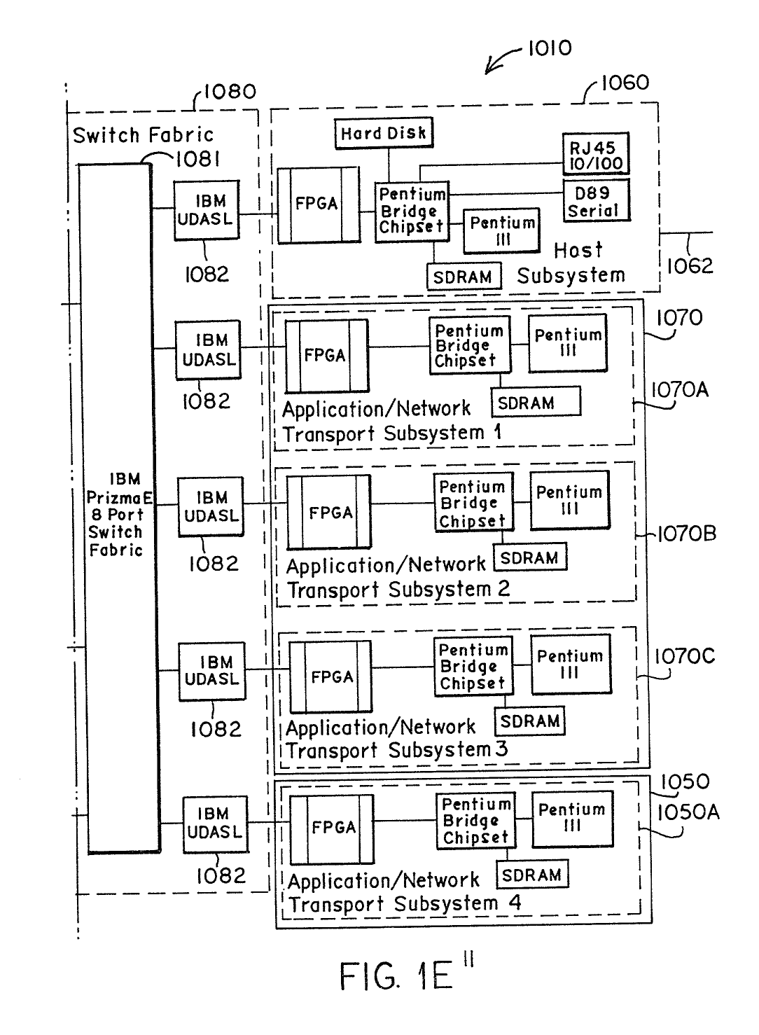

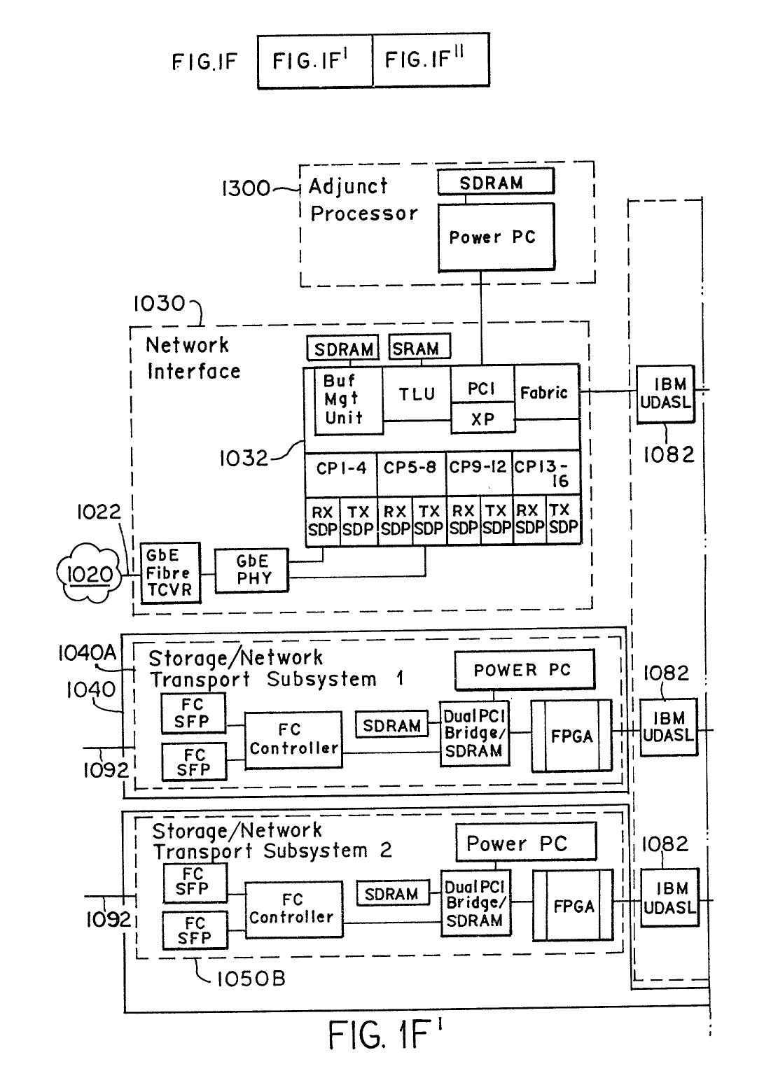

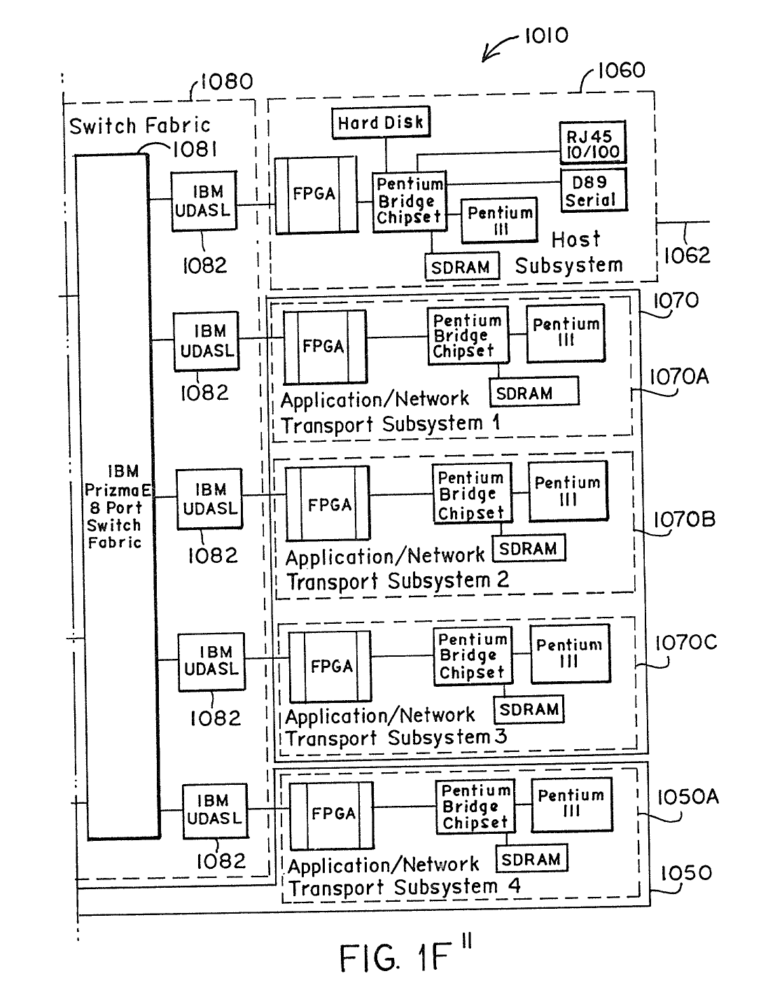

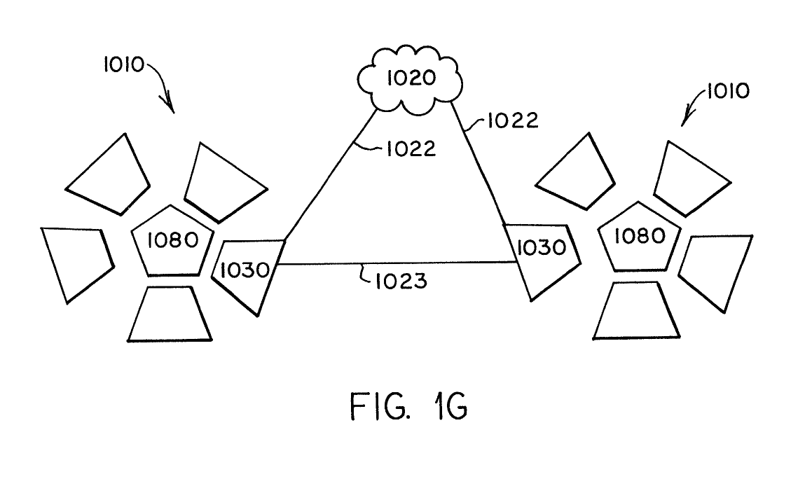

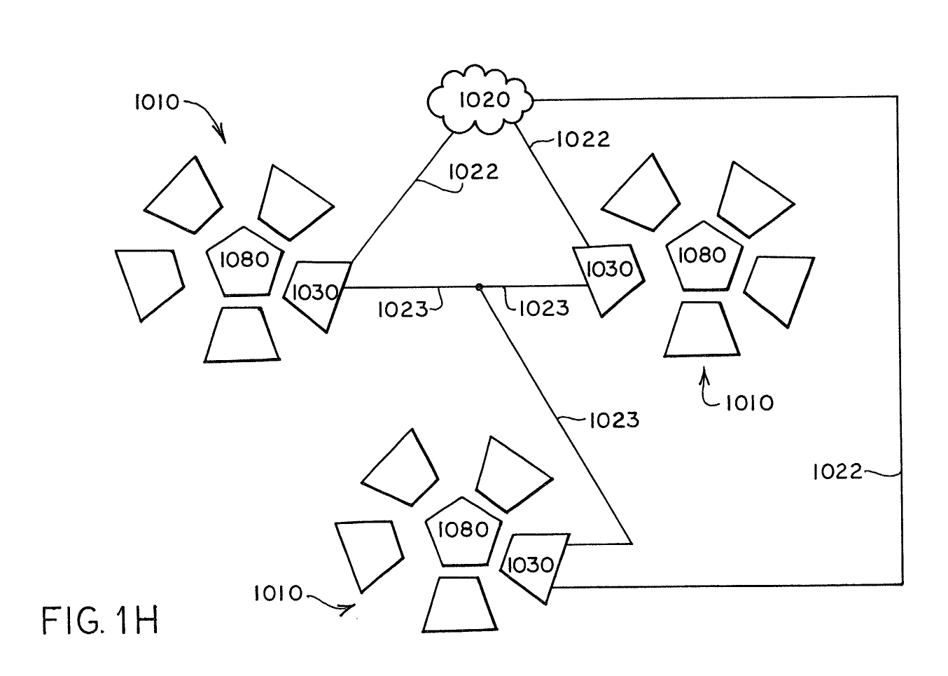

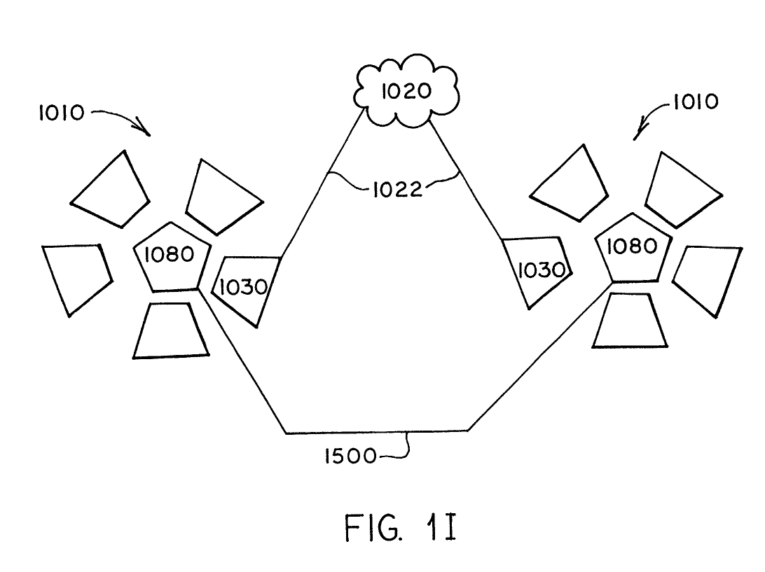

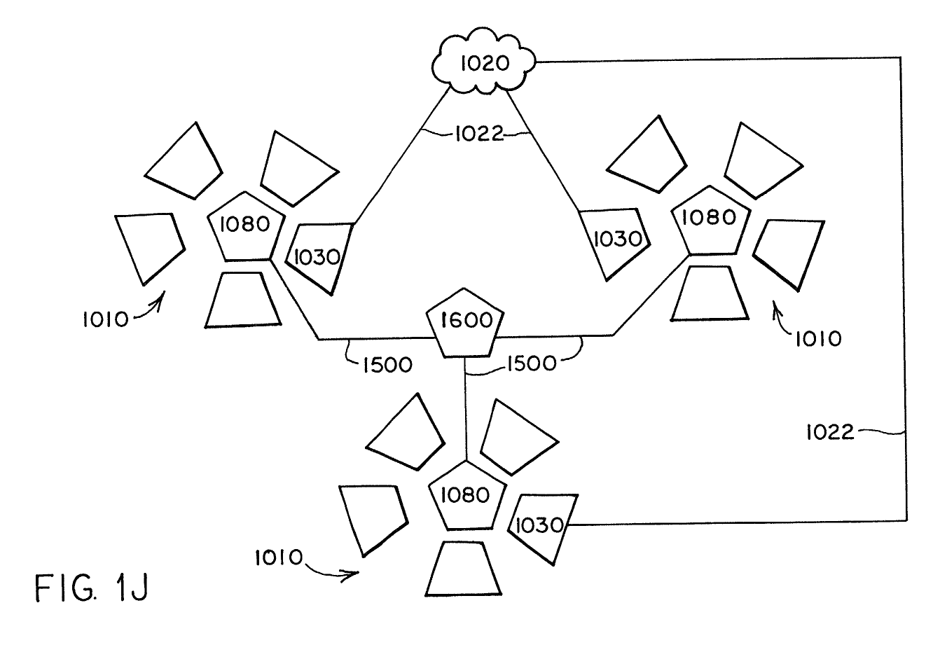

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g. web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the x86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

### DISTRIBUTIVE INTERCONNECT

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multi-server endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an as-needed basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

### NETWORK INTERFACE PROCESSING ENGINE

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Internet Protocol (IP), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, offloading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following concurrently filed U.S. patent applications: Ser. No. ______, entitled “Network Transport Accelerator,” by Bailey et. al; Ser. No. ______ entitled “Single Chassis Network Endpoint System With Network Processor For Load Balancing,” by Richter et. al; and Ser. No. ______ entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in concurrently filed U.S. patent application Ser. No. ______, entitled “Methods and Systems For The Order Serialization Of Information In A Network Processing Environment,” by Richter et. al, the disclosure of which is incorporated herein by reference.

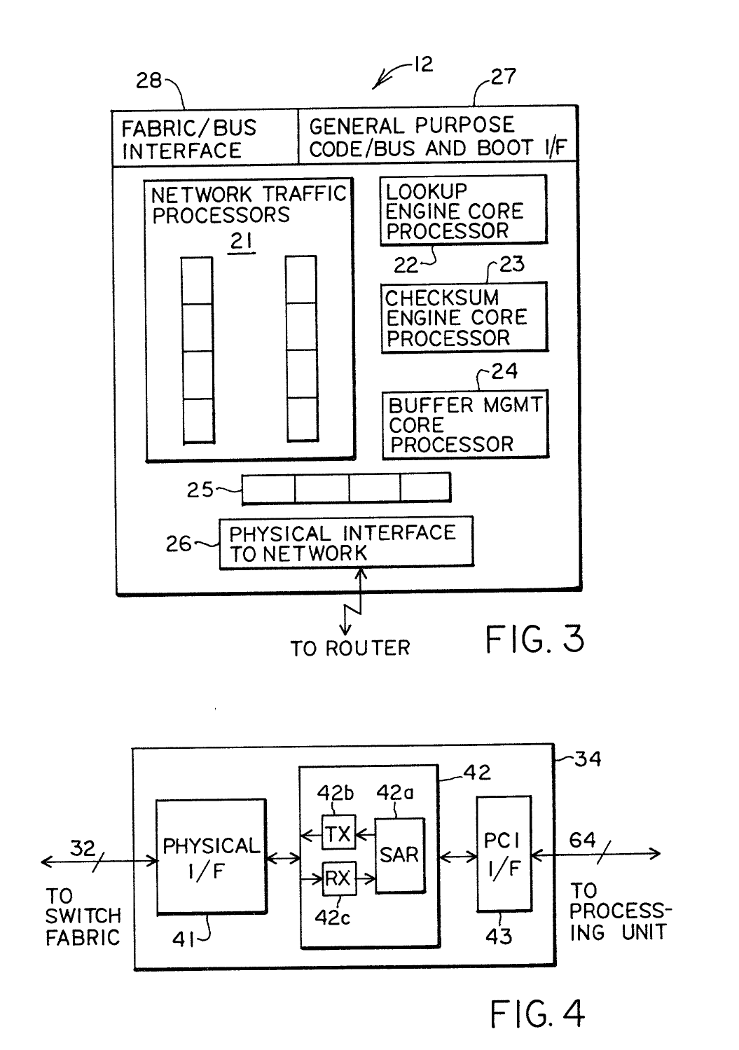

FIG. 3 illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five co-processors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection.

### TRANSPORT/PROTOCOL PROCESSING ENGINE

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/UDP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, session management, data reordering and retransmission, data queueing and flow control, packet header generation, etc. off-loading these tasks from the application processing engine or the network interface processing engine. The transport processing engine 1050 may also handle error checking, likewise freeing up the resources of other processing engines.

### NETWORK INTERFACE/TRANSPORT SPLIT PROTOCOL

The embodiment of FIG. 1A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 2-5) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

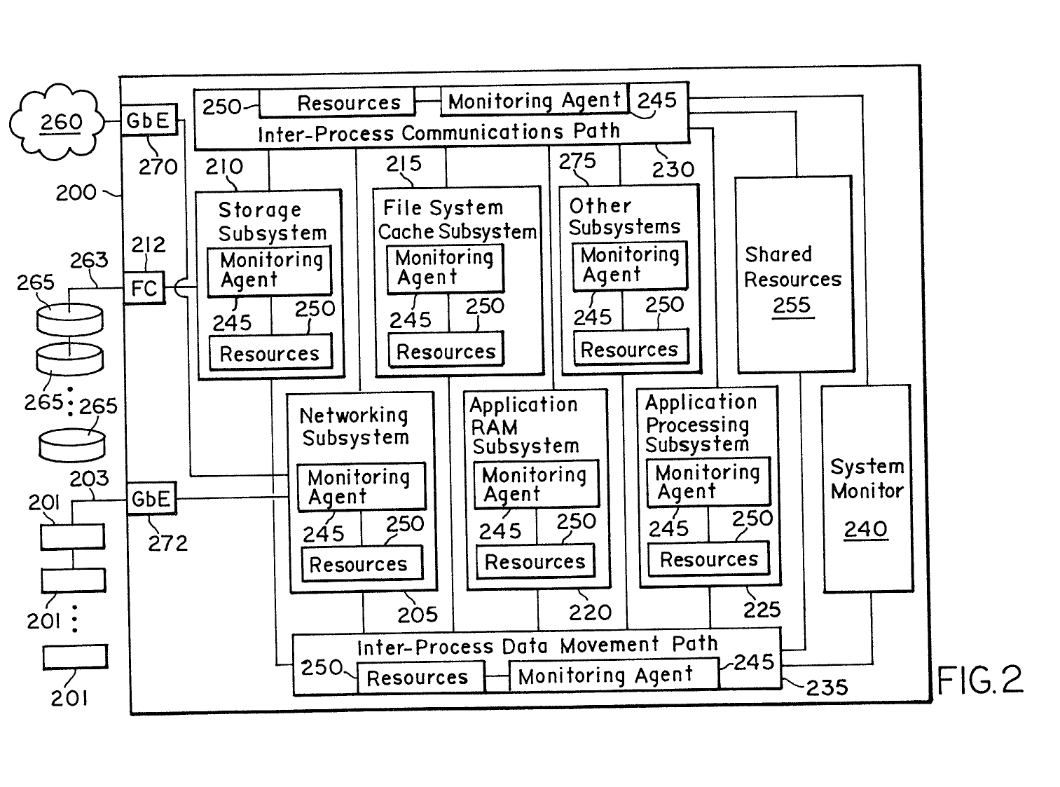

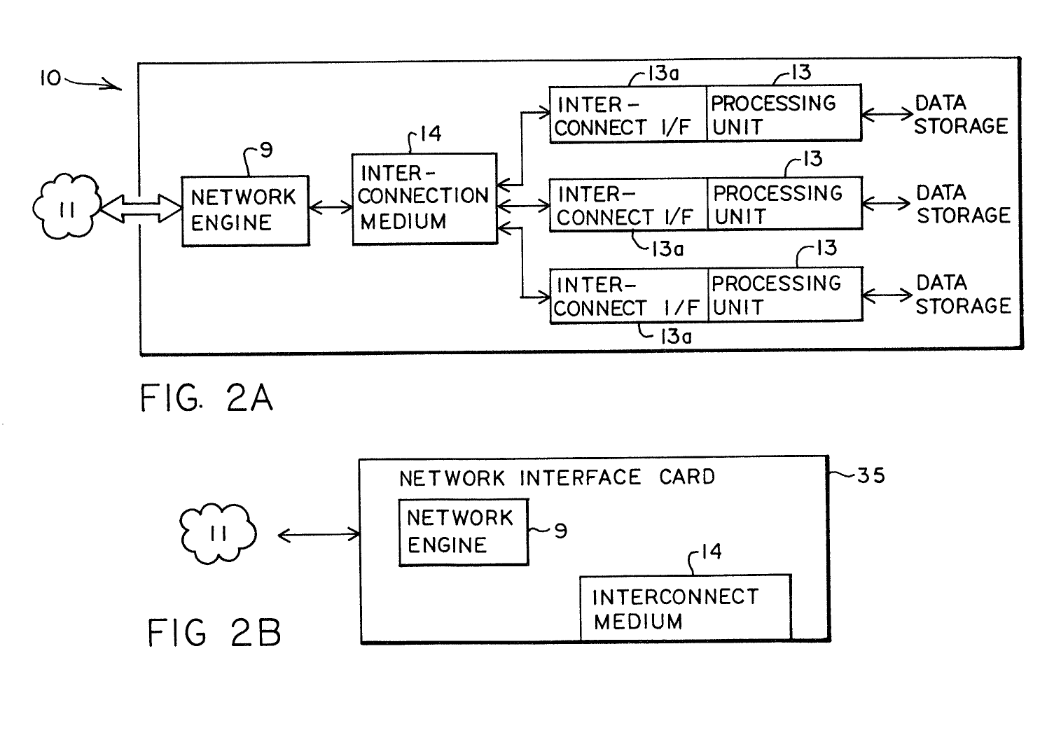

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

### APPLICATION PROCESSING ENGINE

Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. In one embodiment application processing engine 1070 may be a dedicated application processing module based on an INTEL PENTIUM III processor running, for example, on standard x86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

### STORAGE MANAGEMENT ENGINE

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in concurrently filed U.S. patent application Ser. No. ______, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in concurrently filed U.S. patent application Ser. No. ______, entitled “Systems and Methods for Management of Memory in Information Delivery Environments” by Qiu et. al, the disclosure of which is incorporated herein by reference.

### SYSTEM MANAGEMENT ENGINE

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an x86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

### MANAGEMENT PERFORMED BY THE NETWORK INTERFACE

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, fill, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface offloads such functions from the other processing modules and improves system performance by limiting the consumption of system resources by the undesirable traffic. It will be recognized that the filtering example described herein is merely exemplary and many other filter criteria or policies may be provided.

### MULTI-PROCESSOR MODULE DESIGN

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic failover spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1050a may be specially programmed for processing a first type of request received from a network. In the same system, application processing module 1070b and storage processing module 1050b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance.

### CLUSTERS OF SYSTEMS

The systems described herein may also be clustered together in groups of two or more to provide additional processing power, storage connections, bandwidth, etc. Communication between two individual systems each configured similar to content delivery system 1010 may be made through network interface 1022 and/or 1023. Thus, one content delivery system could communicate with another content delivery system through the network 1020 and/or 1024. For example, a storage unit in one content delivery system could send data to a network interface engine of another content delivery system. As an example, these communications could be via TCP/IP protocols. Alternatively, the distributed interconnects 1080 of two content delivery systems 1010 may communicate directly. For example, a connection may be made directly between two switch fabrics, each switch fabric being the distributed interconnect 1080 of separate content delivery systems 1010.

FIGS. 1G-1J illustrate four exemplary clusters of content delivery systems 1010. It will be recognized that many other cluster arrangements may be utilized including more or less content delivery systems. As shown in FIGS. 1G-1J, each content delivery system may be configured as described above and include a distributive interconnect 1080 and a network interface processing engine 1030. Interfaces 1022 may connect the systems to a network 1020. As shown in FIG. 1G, two content delivery systems may be coupled together through the interface 1023 that is connected to each system's network interface processing engine 1030. FIG. 1H shows three systems coupled together as in FIG. 1G. The interfaces 1023 of each system may be coupled directly together as shown, may be coupled together through a network or may be coupled through a distributed interconnect (for example a switch fabric).

FIG. 1I illustrates a cluster in which the distributed interconnects 1080 of two systems are directly coupled together through an interface 1500. Interface 1500 may be any communication connection, such as a copper connection, optical fiber, wireless connection, etc. Thus, the distributed interconnects of two or more systems may directly communicate without communication through the processor engines of the content delivery systems 1010. FIG. 1J illustrates the distributed interconnects of three systems directly communicating without first requiring communication through the processor engines of the content delivery systems 1010. As shown in FIG. 1J, the interfaces 1500 each communicate with each other through another distributed interconnect 1600. Distributed interconnect 1600 may be a switched fabric or any other distributed interconnect.

The clustering techniques described herein may also be implemented through the use of the management interface 1062. Thus, communication between multiple content delivery systems 1010 also may be achieved through the management interface 1062

### EXEMPLARY DATA AND COMMUNICATION FLOW PATHS

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, inter-processor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass network application processing modules 1070a and 1070b. The requested content may then be transferred via the network interface processing module 1030a to the external network 1020. Benefits of bypassing the application processing modules with the delivered content include accelerated delivery of the requested content and offloading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately re-broadcast over interface connection 1022 to the network 1020. Alternatively, content may be proceed through the network interface connection 1023 to the network transport engine 1050 prior to returning to the network interface engine 1030 for re-broadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through network transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 1100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1060 directly to the network interface processing engine 1030 as described with reference to FIG. 1B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Lightening I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

### CONTENT DELIVERY ACCELERATION

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to freeze or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

### EXEMPLARY HARDWARE EMBODIMENTS

FIGS. 1C-1F illustrate just a few of the many multiple network content delivery engine configurations possible with one exemplary hardware embodiment of content delivery system 1010. In each illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. 1C. These fabric interfaces provide a 64/66 Mhz PCI interface to the interface converter circuits 1082. FIG. 4 illustrates a functional block diagram of such a fabric interface 34. As explained below, the interface 34 provides an interface between the processor module bus and the UDASL switch interface converter circuit 1082. As shown in FIG. 4, at the switch fabric side, a physical connection interface 41 provides connectivity at the physical level to the switch fabric. An example of interface 41 is a parallel bus interface complying with the UTOPIA standard. In the example of FIG. 4, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 4, SAR (segmentation and reassembly) unit 42 has appropriate SAR logic 42a for performing segmentation and reassembly tasks for converting messages to fabric cells and vice-versa as well as message classification and message class-to-queue routing, using memory 42b and 42c for transmit and receive queues. This permits different classes of messages and permits the classes to have different priority. For example, control messages can be classified separately from data messages, and given a different priority. All fabric cells and the associated messages may be self routing, and no out of band signaling is required.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. 1C, the network processor 1032 also may be coupled to the network 1020 by using a VITESSE GbE SERDES (serializer-deserializer) device (for example the VSC7123) and an SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2GBaud fibre channel controller. The fibre channel controller enables communication with the fibre channel 1092 when the processor module 1003 is utilized as a storage processing engine 1040. Also illustrated in FIGS. 1C-1F is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIGS. 1C-1F, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

The processor modules 1001 and 1003 of FIG. 1C may be configured in alternative manners to implement the content delivery processing engines such as the network interface processing engine 1030, storage processing engine 1040, transport processing engine 1050, system management processing engine 1060, and application processing engine 1070. Exemplary configurations are shown in FIGS. 1D-1F, however, it will be recognized that other configurations may be utilized.

As shown in FIG. 1D, two Pentium III based processing modules may be utilized as network application processing modules 1070a and 1070b of network application processing engine 1070. The remaining two Pentium III-based processing modules are shown in FIG. 1D configured as network transport/protocol processing modules 1050a and 1050b of network transport/protocol processing engine 1050. The embodiment of FIG. 1D also includes two POWER PC-based processor modules, configured as storage management processing modules 1040a and 1040b of storage management processing engine 1040. A single MOTOROLA C-Port C-5 based network processor is shown employed as network interface processing engine 1030, and a single Pentium III-based processing module is shown employed as system management processing engine 1060.

In FIG. 1E, the same hardware embodiment of FIG. 1C is shown alternatively configured so that three Pentium III-based processing modules function as network application processing modules 1070a, 1070b and 1070c of network application processing engine 1070, and so that the sole remaining Pentium III-based processing module is configured as a network transport processing module 1050a of network transport processing engine 1050. As shown, the remaining processing modules are configured as in FIG. 1D.

In FIG. 1F, the same hardware embodiment of FIG. 1C is shown in yet another alternate configuration so that three Pentium III-based processing modules function as application processing modules 1070a, 1070b and 1070c of network application processing engine 1070. In addition, the network transport processing engine 1050 includes one Pentium III-based processing module that is configured as network transport processing module 1050a, and one POWER PC-based processing module that is configured as network transport processing module 1050b. The remaining POWER PC-based processor module is configured as storage management processing module 1040a of storage management processing engine 1040.

It will be understood with benefit of this disclosure that the hardware embodiment and multiple engine configurations thereof illustrated in FIGS. 1C-1F are exemplary only, and that other hardware embodiments and engine configurations thereof are also possible. It will further be understood that in addition to changing the assignments of individual processing modules to particular processing engines, distributive interconnect 1080 enables the vary processing flow paths between individual modules employed in a particular engine configuration in a manner as described in relation to FIG. 1B. Thus, for any given hardware embodiment and processing engine configuration, a number of different processing flow paths may be employed so as to optimize system performance to suit the needs of particular system applications.

### SINGLE CHASSIS DESIGN

As mentioned above, the content delivery system 1010 may be implemented within a single chassis, such as for example, a 2U chassis. The system may be expanded further while still remaining a single chassis system. In particular, utilizing a multiple processor module or blade arrangement connected through a distributive interconnect (for example a switch fabric) provides a system that is easily scalable. The chassis and interconnect may be configured with expansion slots provided for adding additional processor modules. Additional processor modules may be provided to implement additional applications within the same chassis. Alternatively, additional processor modules may be provided to scale the bandwidth of the network connection. Thus, though describe with respect to a 1 Gbps Ethernet connection to the external network, a 10 Gbps, 40 Gbps or more connection may be established by the system through the use of more network interface modules. Further, additional processor modules may be added to address a system's particular bottlenecks without having to expand all engines of the system. The additional modules may be added during a systems initial configuration, as an upgrade during system maintenance or even hot plugged during system operation.

### ALTERNATIVE SYSTEMS CONFIGURATIONS

Further, the network endpoint system techniques disclosed herein may be implemented in a variety of alternative configurations that incorporate some, but not necessarily all, of the concepts disclosed herein. For example, FIGS. 2 and 2A disclose two exemplary alternative configurations. It will be recognized, however, that many other alternative configurations may be utilized while still gaining the benefits of the inventions disclosed herein.

FIG. 2 is a more generalized and functional representation of a content delivery system showing how such a system may be alternately configured to have one or more of the features of the content delivery system embodiments illustrated in FIGS. 1A-1F. FIG. 2 shows content delivery system 200 coupled to network 260 from which content requests are received and to which content is delivered. Content sources 265 are shown coupled to content delivery system 200 via a content delivery flow path 263 that may be, for example, a storage area network that links multiple content sources 265. A flow path 203 may be provided to network connection 272, for example, to couple content delivery system 200 with other network appliances, in this case one or more servers 201 as illustrated in FIG. 2.

In FIG. 2 content delivery system 200 is configured with multiple processing and memory modules that are distributively interconnected by inter-process communications path 230 and inter-process data movement path 235. Inter-process communications path 230 is provided for receiving and distributing inter-processor command communications between the modules and network 260, and inter-process data movement path 235 is provided for receiving and distributing inter-processor data among the separate modules. As illustrated in FIGS. 1A-1F, the functions of inter-process communications path 230 and inter-process data movement path 235 may be together handled by a single distributive interconnect 1080 (such as a switch fabric, for example), however, it is also possible to separate the communications and data paths as illustrated in FIG. 2, for example using other interconnect technology.

FIG. 2 illustrates a single networking subsystem processor module 205 that is provided to perform the combined functions of network interface processing engine 1030 and transport processing engine 1040 of FIG. 1A. Communication and content delivery between network 260 and networking subsystem processor module 205 are made through network connection 270. For certain applications, the functions of network interface processing engine 1030 and transport processing engine 1050 of FIG. 1A may be so combined into a single module 205 of FIG. 2 in order to reduce the level of communication and data traffic handled by communications path 230 and data movement path 235 (or single switch fabric), without adversely impacting the resources of application processing engine or subsystem module. If such a modification were made to the system of FIG. 1A, content requests may be passed directly from the combined interface/transport engine to network application processing engine 1070 via distributive interconnect 1080. Thus, as previously described the functions of two or more separate content delivery system engines may be combined as desired (e.g., in a single module or in multiple modules of a single processing blade), for example, to achieve advantages in efficiency or cost.

In the embodiment of FIG. 2, the function of network application processing engine 1070 of FIG. 1A is performed by application processing subsystem module 225 of FIG. 2 in conjunction with application RAM subsystem module 220 of FIG. 2. System monitor module 240 communicates with server/s 201 through flow path 203 and Gb Ethernet network interface connection 272 as also shown in FIG. 2. The system monitor module 240 may provide the function of the system management engine 1060 of FIG. 1A and/or other system policy/filter functions such as may also be implemented in the network interface processing engine 1030 as described above with reference to FIG. 1A.

Similarly, the function of network storage management engine 1040 is performed by storage subsystem module 210 in conjunction with file system cache subsystem module 215. Communication and content delivery between content sources 265 and storage subsystem module 210 are shown made directly through content delivery flowpath 263 through fibre channel interface connection 212. Shared resources subsystem module 255 is shown provided for access by each of the other subsystem modules and may include, for example, additional processing resources, additional memory resources such as RAM, etc.

Additional processing engine capability (e.g., additional system management processing capability, additional application processing capability, additional storage processing capability, encryption/decryption processing capability, compression/decompression processing capability, encoding/decoding capability, other processing capability, etc.) may be provided as desired and is represented by other subsystem module 275. Thus, as previously described the functions of a single network processing engine may be sub-divided between separate modules that are distributively interconnected. The sub-division of network processing engine tasks may also be made for reasons of efficiency or cost, and/or may be taken advantage of to allow resources (e.g., memory or processing) to be shared among separate modules. Further, additional shared resources may be made available to one or more separate modules as desired.

Also illustrated in FIG. 2 are optional monitoring agents 245 and resources 250. In the embodiment of FIG. 2, each monitoring agent 245 may be provided to monitor the resources 250 of its respective processing subsystem module, and may track utilization of these resources both within the overall system 200 and within its respective processing subsystem module. Examples of resources that may be so monitored and tracked include, but are not limited to, processing engine bandwidth, Fibre Channel bandwidth, number of available drives, IOPS (input/output operations per second) per drive and RAID (redundant array of inexpensive discs) levels of storage devices, memory available for caching blocks of data, table lookup engine bandwidth, availability of RAM for connection control structures and outbound network bandwidth availability, shared resources (such as RAM) used by streaming application on a per-stream basis as well as for use with connection control structures and buffers, bandwidth available for message passing between subsystems, bandwidth available for passing data between the various subsystems, etc.

Information gathered by monitoring agents 245 may be employed for a wide variety of purposes including for billing of individual content suppliers and/or users for pro-rata use of one or more resources, resource use analysis and optimization, resource health alarms, etc. In addition, monitoring agents may be employed to enable the deterministic delivery of content by system 200 as described further herein.

In operation, content delivery system 200 of FIG. 2 may be configured to wait for a request for content or services prior to initiating content delivery or performing a service. A request for content, such as a request for access to data, may include, for example, a request to start a video stream, a request for stored data, etc. A request for services may include, for example, a request for to run an application, to store a file, etc. A request for content or services may be received from a variety of sources. For example, if content delivery system 200 is employed as a stream server, a request for content may be received from a client system attached to a computer network or communication network such as the Internet. In a larger system environment, e.g., a data center, a request for content or services may be received from a separate subcomponent or a system management processing engine, that is responsible for performance of the overall system or from a sub-component that is unable to process the current request. Similarly, a request for content or services may be received by a variety of components of the receiving system. For example, if the receiving system is a stream server, networking subsystem processor module 205 might receive a content request. Alternatively, if the receiving system is a component of a larger system, e.g., a data center, system management processing engine may be employed to receive the request.

Upon receipt of a request for content or services, the request may be filtered by system monitor 240. Such filtering may serve as a screening agent to filter out requests that the receiving system is not capable of processing (e.g., requests for file writes from read-only system embodiments, unsupported protocols, content/services unavailable on system 200, etc.). Such requests may be rejected outright and the requestor notified, may be re-directed to a server 201 or other content delivery system 200 capable of handling the request, or may be disposed of any other desired manner.

Referring now in more detail to one embodiment of FIG. 2 as may be employed in a stream server configuration, networking processing subsystem module 205 may include the hardware and/or software used to run TCP/IP (Transmission Control Protocol/Internet Protocol), UDP/IP (User Datagram Protocol/Internet Protocol), RTP (Real-Time Transport Protocol), Internet Protocol (IP), Wireless Application Protocol (WAP) as well as other networking protocols. Network interface connections 270 and 272 may be considered part of networking subsystem processing module 205 or as separate components. Storage subsystem module 210 may include hardware and/or software for running the Fibre Channel (FC) protocol, the SCSI (Small Computer Systems Interface) protocol, iSCSI protocol as well as other storage networking protocols. FC interface 212 to content delivery flowpath 263 may be considered part of storage subsystem module 210 or as a separate component. File system cache subsystem module 215 may include, in addition to cache hardware, one or more cache management algorithms as well as other software routines.

Application RAM subsystem module 220 may function as a memory allocation subsystem and application processing subsystem module 225 may function as a stream-serving application processor bandwidth subsystem. Among other services, application RAM subsystem module 220 and application processing subsystem module 225 may be used to facilitate such services as the pulling of content from storage and/or cache, the formatting of content into RTSP (Real-Time Streaming Protocol) or another streaming protocol as well the passing of the formatted content to networking subsystem 205.

As previously described, system monitor module 240 may be included in content delivery system 200 to manage one or more of the subsystem processing modules, and may also be used to facilitate communication between the modules.

In part to allow communications between the various subsystem modules of content delivery system 200, inter-process communication path 230 may be included in content delivery system 200, and may be provided with its own monitoring agent 245. Inter-process communications path 230 may be a reliable protocol path employing a reliable IPC (Interprocess Communications) protocol. To allow data or information to be passed between the various subsystem modules of content delivery system 200, inter-process data movement path 235 may also be included in content delivery system 200, and may be provided with its own monitoring agent 245. As previously described, the functions of inter-process communications path 230 and inter-process data movement path 235 may be together handled by a single distributive interconnect 1080, that may be a switch fabric configured to support the bandwidth of content being served.

In one embodiment, access to content source 265 may be provided via a content delivery flow path 263 that is a fibre channel storage area network (SAN), a switched technology. In addition, network connectivity may be provided at network connection 270 (e.g., to a front end network) and/or at network connection 272 (e.g., to a back end network) via switched gigabit Ethernet in conjunction with the switch fabric internal communication system of content delivery system 200. As such, that the architecture illustrated in FIG. 2 may be generally characterized as equivalent to a networking system.

One or more shared resources subsystem modules 255 may also be included in a stream server embodiment of content delivery system 200, for sharing by one or more of the other subsystem modules. Shared resources subsystem module 255 may be monitored by the monitoring agents 245 of each subsystem sharing the resources. The monitoring agents 245 of each subsystem module may also be capable of tracking usage of shared resources 255. As previously described, shared resources may include RAM (Random Access Memory) as well as other types of shared resources.

Each monitoring agent 245 may be present to monitor one or more of the resources 250 of its subsystem processing module as well as the utilization of those resources both within the overall system and within the respective subsystem processing module. For example, monitoring agent 245 of storage subsystem module 210 may be configured to monitor and track usage of such resources as processing engine bandwidth, Fibre Channel bandwidth to content delivery flow path 263, number of storage drives attached, number of input/output operations per second (IOPS) per drive and RAID levels of storage devices that may be employed as content sources 265. Monitoring agent 245 of file system cache subsystem module 215 may be employed monitor and track usage of such resources as processing engine bandwidth and memory employed for caching blocks of data. Monitoring agent 245 of networking subsystem processing module 205 may be employed to monitor and track usage of such resources as processing engine bandwidth, table lookup engine bandwidth, RAM employed for connection control structures and outbound network bandwidth availability. Monitoring agent 245 of application processing subsystem module 225 may be employed to monitor and track usage of processing engine bandwidth. Monitoring agent 245 of application RAM subsystem module 220 may be employed to monitor and track usage of shared resource 255, such as RAM, which may be employed by a streaming application on a per-stream basis as well as for use with connection control structures and buffers. Monitoring agent 245 of inter-process communication path 230 may be employed to monitor and track usage of such resources as the bandwidth used for message passing between subsystems while monitoring agent 245 of inter-process data movement path 235 may be employed to monitor and track usage of bandwidth employed for passing data between the various subsystem modules.

The discussion concerning FIG. 2 above has generally been oriented towards a system designed to deliver streaming content to a network such as the Internet using, for example, Real Networks, Quick Time or Microsoft Windows Media streaming formats. However, the disclosed systems and methods may be deployed in any other type of system operable to deliver content, for example, in web serving or file serving system environments. In such environments, the principles may generally remain the same. However for application processing embodiments, some differences may exist in the protocols used to communicate and the method by which data delivery is metered (via streaming protocol, versus TCP/IP windowing).

FIG. 2A illustrates an even more generalized network endpoint computing system that may incorporate at least some of the concepts disclosed herein. As shown in FIG. 2A, a network endpoint system 10 may be coupled to an external network 11. The external network 11 may include a network switch or router coupled to the front end of the endpoint system 10. The endpoint system 10 may be alternatively coupled to some other intermediate network node of the external network. The system 10 may further include a network engine 9 coupled to an interconnect medium 14. The network engine 9 may include one or more network processors. The interconnect medium 14 may be coupled to a plurality of processor units 13 through interfaces 13a. Each processor unit 13 may optionally be couple to data storage (in the exemplary embodiment shown each unit is couple to data storage). More or less processor units 13 may be utilized than shown in FIG. 2A.

The network engine 9 may be a processor engine that performs all protocol stack processing in a single processor module or alternatively may be two processor modules (such as the network interface engine 1030 and transport engine 1050 described above) in which split protocol stack processing techniques are utilized. Thus, the functionality and benefits of the content delivery system 1010 described above may be obtained with the system 10. The interconnect medium 14 may be a distributive interconnection (for example a switch fabric) as described with reference to FIG. 1A. All of the various computing, processing, communication, and control techniques described above with reference to FIGS. 1A-1F and 2 may be implemented within the system 10. It will therefore be recognized that these techniques may be utilized with a wide variety of hardware and computing systems and the techniques are not limited to the particular embodiments disclosed herein.

The system 10 may consist of a variety of hardware configurations. In one configuration the network engine 9 may be a stand-alone device and each processing unit 13 may be a separate server. In another configuration the network engine 9 may be configured within the same chassis as the processing units 13 and each processing unit 13 may be a separate server card or other computing system. Thus, a network engine (for example an engine containing a network processor) may provide transport acceleration and be combined with multi-server functionality within the system 10. The system 10 may also include shared management and interface components. Alternatively, each processing unit 13 may be a processing engine such as the transport processing engine, application engine, storage engine, or system management engine of FIG. 1A. In yet another alternative, each processing unit may be a processor module (or processing blade) of the processor engines shown in the system of FIG. 1A.

FIG. 2B illustrates yet another use of a network engine 9. As shown in FIG. 2B, a network engine 9 may be added to a network interface card 35. The network interface card 35 may further include the interconnect medium 14 which may be similar to the distributed interconnect 1080 described above. The network interface card may be part of a larger computing system such as a server. The network interface card may couple to the larger system through the interconnect medium 14. In addition to the functions described above, the network engine 9 may perform all traditional functions of a network interface card.

It will be recognized that all the systems described above (FIGS. 1A, 2, 2A, and 2B) utilize a network engine between the external network and the other processor units that are appropriate for the function of the particular network node. The network engine may therefore offload tasks from the other processors. The network engine also may perform “look ahead processing” by performing processing on a request before the request reaches whatever processor is to perform whatever processing is appropriate for the network node. In this manner, the system operations may be accelerated and resources utilized more efficiently.

### DETERMINISTIC INFORMATION MANAGEMENT

In certain embodiments, the disclosed methods and systems may be advantageously employed for the deterministic management of information (e.g., content, data, services, commands, communications, etc.) at any level (e.g., file level, bit level, etc.). As used herein, “deterministic information management” includes the manipulation of information (e.g., delivery, routing or re-routing, serving, storage, caching, processing, etc.) in a manner that is based at least partially on the condition or value of one or more system or subsystem parameters. Examples of such parameters will be discussed further below and include, but are not limited to, system or subsystem resources such as available storage access, available application memory, available processor capacity, available network bandwidth, etc. Such parameters may be utilized in a number of ways to deterministically manage information. For example, requests for information delivery may be rejected or queued based on availability of necessary system or subsystem resources, and/or necessary resources may be allocated or reserved in advance of handling a particular information request, e.g., as part of an end-to-end resource reservation scheme. Managing information in a deterministic manner offers a number of advantages over traditional information management schemes, including increased hardware utilization efficiency, accelerated information throughput, and greater information handling predictability. Features of deterministic information management may also be employed to enhance capacity planning and to manage growth more easily.

Deterministic information management may be implemented in conjunction with any system or subsystem environment that is suitable for the manipulation of information, including network endpoint systems, intermediate node systems and endpoint/intermediate hybrid systems discussed elsewhere herein. Specific examples of such systems include, but are not limited to, storage networks, servers, switches, routers, web cache systems, etc. It will be understood that any of the information delivery system embodiments described elsewhere herein, including those described in relation to FIGS. 1A and 2, may be employed to manage information in a deterministic manner.

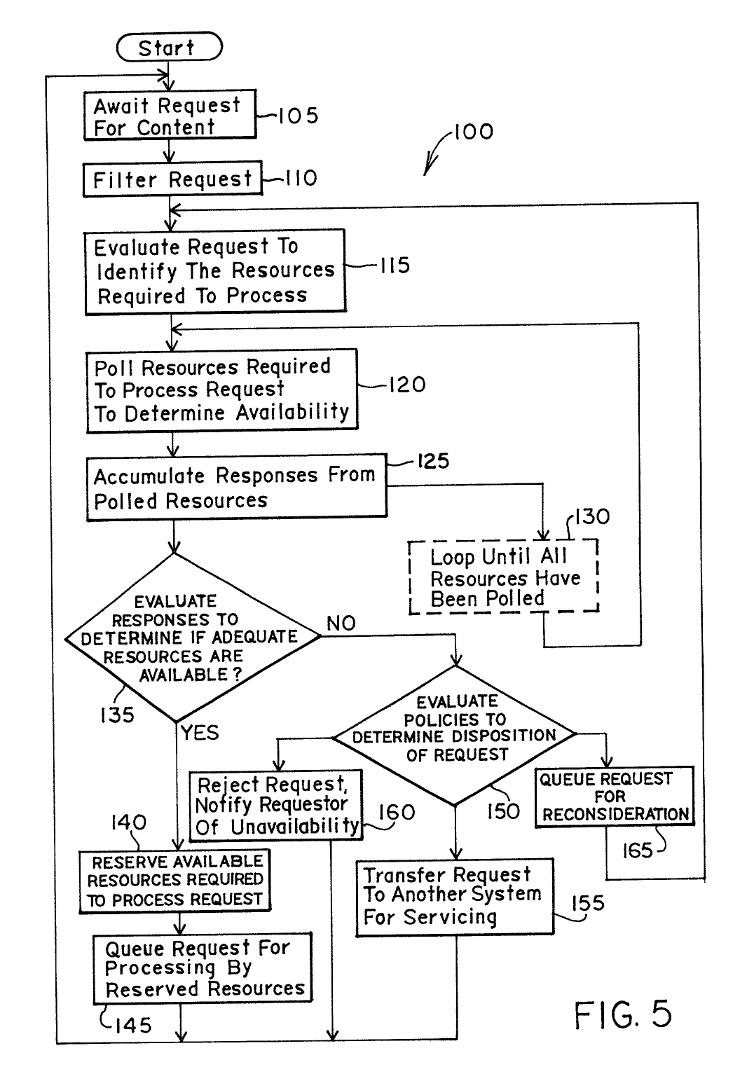

FIG. 5 is a flow diagram illustrating one embodiment of a method 100 for deterministic delivery of content in response to a request for the same. Although FIG. 5 is described in relation to content delivery, it will be understood with benefit of this disclosure that the deterministic methods and systems described herein may be used in a wide variety of information management scenarios, including application serving, and are therefore not limited to only processing requests for content. It will also be understood that the types of content that may be deterministically managed or delivered include any types of content described elsewhere herein, e.g., static content, dynamic content, etc.

With regard to deterministic content delivery methods such as that illustrated in FIG. 5, it will be understood that different types of content may be deterministically managed in different ways to achieved optimum efficiency. For example, when employed to deliver streaming content, such as video or audio streams, the disclosed methods may be advantageously employed to provide increased stability and predictability in stream delivery by, among other things, predicting the capacity of a content delivery system to deliver many long-lived streams. Each such stream requires a certain amount of resources, which may be identified at the time the stream is opened. For web page delivery, such as HTTP serving, requests may be handled as aggregates.

When employed with an information management system such as the content delivery system embodiment illustrated in FIG. 2, method 100 of FIG. 5 may be used to allow a system monitor, a plurality of subsystems and one or more shared resources of a system to effectively interact and provide deterministic delivery of data and services. However, it will be understood that method 100 may be implemented with a variety of other information management system configurations to allow deterministic interaction between system components, for example, between the multiple content delivery engines described in relation to FIG. 1A. Furthermore, FIG. 5 represents just one exemplary set of method steps that may be employed to implement deterministic interaction between system components, with it being understood that any other number, type and/or sequence of method steps suitable for enabling deterministic interaction between two or more components of an information management system may be employed. Selection of suitable steps may be made based on a variety of individual system characteristics, for example, system hardware, system function and environment, system cost and capabilities, etc.

Method 100 of FIG. 5 generally begins at step 105 where a request for content, is awaited. A request for content, as is the case with a request for other information (e.g. data, services, etc.), may be received from a variety of sources. For example, if the system is employed in a stream server environment, the request for content may be received from a client system attached to a computer network or communication network such as the Internet, or any of the other sources of requests described elsewhere herein, including from an overloaded subcomponent of the system which is presently unable to process the current request for content.

Upon receipt of a request for content at step 105, the request for content may be filtered at step 110 by, for example, one or more processing engines or modules that perform the function of a system monitor. Filtering the request for content may serve a variety of purposes. For example, the filtering performed at step 110 may serve as a screening agent to reject requests for content that the receiving system is not capable of processing. Step 110 may also be employed as a first parsing of the received requests for content such that a subsequent level of filtering is employed to further direct the work or requests for content to an appropriate subsystem or system area for processing. It will be understood that other filtering techniques and purposes may also be employed in conjunction with the disclosed systems and methods.

Once the request for content has been filtered, method 100 proceeds to step 115 where the filtered request for content is evaluated. Evaluation of the request for content may be performed by, for example, a system monitor or another subsystem or combination of subsystems capable of evaluating a request for content. With regard to step 115, a request for content may be evaluated in a number of different ways in relation to one or more system or subsystem parameters. For example, a request for content may be evaluated in relation to the requirements for fulfilling the request, e.g., the identified resources that are going to be required to process the particular request for content. As an illustration, a request for access to a streaming video file may be evaluated in relation to one or more of the following requirements: a need for access to storage, a need for processor usage, a need for network bandwidth to enable the data to be streamed from storage, as well as a need for other resources. Evaluation of a request in this manner may be used to enable a system monitor to determine the availability of the required resources, by first identifying what resources will be required to process the request for content. Additional details regarding evaluation of a request for content will be discussed below.

After the resources required to process the current request for content have been identified at step 115, method 100 proceeds to step 120. At step 120, the required resources identified in step 115 may be polled to determine whether the current workload of the required resources is such that the required resources will be available to process the current request for content upon its acceptance. Available resources may be defined, for example, as those required resources that are immediately available to process a request for content, or those resources that will be available within a predefined amount of time. Polling of each of the required resources may occur in parallel or serial manner.

Using the embodiment of FIG. 2 to illustrate, a system operable to process a request for content may include a system monitor 240, a plurality of subsystems (e.g., 210, 215, etc.) and one or more shared resources 255. Each subsystem may include one or more resources 250 that enable that subsystem to perform its respective tasks, and a monitoring agent 245 that is configured to monitor, control, reserve and otherwise manage those resources. In this embodiment, the polling at step 120 may involve the system monitor 240 communicating its resource needs to the monitoring agent 245 of the subsystem having the required resources to process the current request for content. Upon receipt of such communication, the monitoring agent 245 evaluates the workload of the resources 250 for which it is responsible to determine whether there is or there will be enough available resources to process the request for content under consideration.

For example, if the system monitor 240 has indicated that it needs four 4 (four) MB (megabytes) of memory from an application RAM (Random Access Memory) subsystem and the monitoring agent 245 of the application RAM subsystem 220 determines that only 1 MB of memory is available, the system monitor 240 will be notified by the monitoring agent 245 of the unavailability of the application RAM subsystem 220. As a result of the polling of the required resources, a response indicative of the availability of the required resources may be generated by the monitoring agent 245, and transferred to the polling unit, i.e., the system monitor 240. It will be understood that similar interaction between system monitor 240 and respective monitoring agents 245 of other subsystems may occur as appropriate for a given system configuration and a given information request.

In an alternate embodiment, instead of polling the subsystems, a system monitor may receive notifications generated by and transmitted from one or more of the various subsystems. Such notifications may be indicative of the availability of the resources of the various subsystems. For example, if RAM subsystem 220 of FIG. 2 has no available memory, RAM subsystem 220 may automatically notify the system monitor 240 that it is out of memory and therefore unable to take on additional requests for processing. When RAM subsystem resources become or are becoming available, RAM subsystem 220 may automatically generate and transmit a notification to the system monitor 240 indicative of the fact that the RAM subsystem is now or is becoming available to take on additional requests for processing.

Using the above-described automatic notification scheme, a given subsystem may inform a system monitor that the subsystem has reached a threshold of utilization and that the system monitor should slow down on accepting requests. Once a subsystem frees up some of its resources, the given subsystem may then notify the system monitor that it is available or is becoming available and that the system monitor may resume normal operation. Such an implementation allows the system monitor to maintain an awareness of the availability of the subsystems and their resources without requiring the system monitor to poll the subsystems, although it will be understood that both polling and notification functions may be employed together in a given system embodiment. Thus, it will be understood that the various methods and systems disclosed herein may be implemented in various ways to accomplish communication of the status of subsystem resource availability in any manner suitable for accomplishing the deterministic management of information disclosed herein.

At step 125 of method 100, the system monitor accumulates the responses to the resource polls or resource notifications for later evaluation. In one embodiment of method 100, optional step 130 may also be included. At step 130, method 100 loops until all responses or notifications have been received from concerning the identified required resources before allowing method 100 to proceed to step 135.

At step 135, the responses to the resource polls or resource notifications are evaluated, for example, by a system monitor. Evaluation of the resource responses or notifications may involve evaluation of any one or more desired characteristics of the resources including, but not limited to, current availability or estimated time until availability of adequate resources, capability of available resources in relation to a particular request, etc. In one embodiment, evaluation may involve determining whether adequate resources are available, or will be available within a specific time, to process the request for content under consideration. For example, method 100 may require that all of the resources required to process a request for content be immediately available, prior to proceeding toward acceptance of a content request.

Alternatively, evaluation of the responses from the polled resources may entail ensuring that a defined minimum portion of the required resources are immediately available or will become available in a specified amount of time. Such a specified amount of time may be defined on a system-level basis, automatically set by policy on a system-level basis, and/or automatically set by policy on a request-by-request basis. For example, a policy may be implemented to set a maximum allowable time frame for delivery of content based on one or more parameters including, but not limited to, type of request, type of file or service requested, origin of request, identification of the requesting user, priority information (e.g., QoS, Service Level Agreement (“SLA”), etc.) associated with a particular request, etc. A specified maximum allowable time frame may also be set by policy on a system level basis based on one or more parameters including, but not limited to, workload of the present system, resource availability or workload of other linked systems, etc. It will be understood that other guidelines or definitions for acceptable resource availability may be employed.

If, at step 135, the required resources are determined to be available within the guidelines specified for method 100 by one or more system policies, method 100 may proceed to step 140. At step 140, the resources required to process the request for content under consideration may be reserved. For example, using FIG. 2 as an illustration again, reservation of identified required resources 250 may be accomplished by the system monitor 240 or, alternatively, by a combination of the system monitor 240 and the appropriate monitoring agents 245 responsible for each of the identified required resources 250. In one embodiment, reservation of resources includes setting aside that portion of the available resources, or of the resources that will become available within a given time, that has been determined to be required to process the request for content, e.g., a block of memory, a portion of processor power, a portion of network and storage access bandwidth, etc. Reservation of the required resources may be employed to ensure that the current request for content will be readily processed.

Once the required resources have been reserved at step 140, method 100 proceeds to step 145. At step 145, the request for content may be queued for processing by the reserved resources. Upon queuing the request for content at step 145, method 100 returns to step 105 where receipt of a subsequent request for content is awaited by the system.

If, at step 135, it is determined that the required resources are not available to process the request for content, method 100 may proceed to step 150. At step 150, one or more handling policies may be evaluated to determine the proper disposition of the request for content. In this regard, a variety of handling policies (e.g., steps 155, 160 and 165 of FIG. 5) may be made available to properly dispose of requests for content for which the identified resources required to process a request are not available. A given handling policy may be implemented according to one or more system or subsystem parameters in any manner appropriate for the given system environment.

Examples of possible parameters that may be evaluated at step 150 to determine the appropriate handling policy for a given request include, but are not limited to, resource availability and capability of other content delivery systems (e.g., one or more other clustered systems), capability and/or anticipated time until availability of resources in the present content delivery system, the source of the request, the request priority (e.g., SLA, QoS bit set), etc.

In one exemplary embodiment, it is possible at step 150 to select a given policy (e.g., 155, 160 or 165) on a request-by-request or user-by-user basis, for example, based on a specified maximum allowable content delivery time frame that may vary for each request according to one or more parameters such as type of request, type of file or service requested, origin of request, identification of the requesting user, priority information (e.g. QoS, Service Level Agreement (“SLA”), etc.) associated with a particular request, etc. For example, requests from different users and/or requests having different priority codes may be individually associated with different maximum time frame values for delivery of content. When it is determined at step 135 that system resources for the current system won't be available for a given period of time, this given period of time may be compared with the maximum allowable content delivery time frame associated with each request to determine disposition of that request on an individualized basis. Thus, depending on the maximum allowable time frame associated with each request, it is possible that individual requests may be disposed of at step 150 via different policies even when the resource availability time determined at step 135 is the same for each request, e.g., some requests may be immediately transferred to another system via step 155, some requests may be rejected via step 160 and/or some requests may be re-considered via step 165. It will be understood that combinations of different policies and/or maximum content delivery time frames may be implemented in a variety of ways as necessary to achieve desired disposition of different requests.

As illustrated in FIG. 5, evaluation of the handling policies may lead to step 155 where disposal of the requests for content entails transferring the request to another system for processing when identified required resources of the present system are not immediately available or will not become available within a specified period of time. For example, the request for content may be transferred, i.e., by the system monitor, to a separate content delivery system that is known to have resources immediately available or available within a specified period of time. Alternatively, the request for content may be transferred to the next sequential system in a chain of content delivery systems, and where the next system proceeds through a method similar to method 100 to determine its ability to process the request for content.

Upon transferring the request for content to another system at step 155, method 100 of the system returns to step 105 where a subsequent request for content is awaited. It will be understood that a request for content may be transferred to another system that is similarly configured as the present system (e.g., as in a cluster of similar content delivery systems), or to another type of system that is configured differently (e.g., with differing resource types and/or capabilities). In the case of clustered systems, system monitors (or other appropriate subsystem modules) of the individual systems of a cluster may be configured to communicate with each other for purposes of sharing system capability and/or resource availability information with other systems to facilitate efficient transference and handling of requests within a system cluster.

It will also be understood that inter-system transfer of information (e.g., data, content, requests for content, commands, resource status information, etc.) between two or more clustered systems may be managed in a deterministic fashion in a manner similar to that described herein for the intra-system transfer of information between individual processing engines within a single information management system. Deterministic management of intersystem information transfer may be enhanced by distributive interconnection of multiple clustered systems, either internally (e.g., by distributive interconnection of individual distributed interconnects as shown in FIG. 1J) or externally (e.g., by distributive interconnection of individual system network interface processing engines as shown in FIG. 1H). In either case, deterministic transfer of information between individual systems may be managed in a deterministic fashion using any suitable management processing configuration, for example, by using a separate dedicated inter-system management processing module or by using one or more of the existing system monitor processing modules of the individual clustered systems. Individual clusters of systems may in turn be distributively interconnected and information transfer therebetween deterministically managed in a similar fashion, with the number of superimposed levels of deterministic information management being virtually unlimited. Thus, the disclosed methods and systems for deterministic management of information may be advantageously implemented on a variety of scales and/or at multiple system levels as so desired.

Another exemplary policy that may be implemented to address situations in which the current system is unable to process a request for content is illustrated at step 160 where the request for content may be rejected. Similar to step 155, a request for content may be so rejected when the identified required resources of the present system are not immediately available or will not be available within a specified period of time. Such a policy may be implemented, for example, where no other separate clustered system is known to be capable of handling the request, and/or is known to have the necessary resources immediately available or available within a specified period of time. In addition to rejecting the request for content, step 155 may also include notifying the source of the request for content of the rejection and of the inability of the present system to process the request for content. Once the request for content has been rejected at step 160, method 100 returns to step 105 where a subsequent request for content is awaited.

Yet another exemplary policy that may be implemented based on the evaluation step 150 is indicated generally at step 165. At step 165, a request for content may be re-queued for reconsideration by the present system. Re-queuing of a request may include returning to step 115 where the request for content is re-evaluated to identify the resources required for its processing. Such a re-queue may be desirable, for example, when the identified required resources of the present system and of other systems are not immediately available or will not be available within a specified period of time, but when such resources are anticipated to become available at some point in the future. Furthermore, selected types of requests may also be targeted for re-queue rather than rejection when resources are not available. For example, higher priority requests (e.g., based on SLA or QoS bit set) may be re-queued for expedited processing, while similar but lower priority requests are rejected.

It will be understood with benefit of this disclosure that the three handling policies described above in relation to step 150 are exemplary only, and that not all three need be present at step 150. Further, it will be understood that other types of handling policies may be implemented at step 150 as desired to fit the needs of a particular application environment, including additional or alternative policies for treatment of requests other than those described above, and policies that consider alternate or additional system or subsystem parameters.

Turning now to FIG. 2 in greater detail, it will be understood in view of the above discussion that the subsystems of content delivery system 200 may be configured to interact in a deterministic manner if so desired. The ability to manage information in a deterministic fashion may be made possible by virtue of the fact that each subsystem module has a monitoring agent 245 that is aware of one or more subsystem module resources 250 and the utilization of those resources within the respective subsystem and/or overall system 200.

As mentioned above, monitoring agents 245 of each subsystem may be configured to be capable of evaluating the current workload of the resources 250 of the respective subsystem and of reporting the availability of such resources to system monitor 240, either automatically or upon a polling by system monitor 240. Upon receipt of a request, system monitor 240 and one or more individual monitoring agents 245 may individually or together function to either accept the request and reserve the required resources 250 for the request if the resources are available, or to reject the request if one or more subsystem resources 250 required to process the request are not available.

In one embodiment, content delivery system 200 of FIG. 2 may be configured to deterministically deliver content (e.g., one or more video streams) by employing individual monitoring agents 245 in the following roles. Monitoring agent 245 of storage subsystem module 210 may be configured to monitor and reserve such resources as processing engine bandwidth, Fiber Channel bandwidth to content delivery flow path 263, number of available storage devices 265, number of IOPS available per device, and taking into account RAID levels (hardware or software). Monitoring agent 245 of file system caching subsystem module 215 may be configured to monitor and reserve such resources as processing engine bandwidth and memory available for caching blocks of data. Monitoring agent 245 of networking subsystem processing module 205 may be configured to monitor and reserve such resources as processing engine bandwidth, table lookup engine bandwidth, availability of RAM for connection control structures and outbound network bandwidth availability. Monitoring agent 245 of application processing subsystem module 225 may be configured to monitor and reserve processing engine bandwidth. Monitoring agent 245 of other subsystem module 275 may be configured to monitor and reserve resources appropriate to the processing engine features provided therein.

With regard to shared resources 255 of FIG. 2, it will be understood that in a deterministic content delivery embodiment, shared resources 255 may be provided and controlled by individual monitoring agents 245 of each subsystem module sharing the resources 255. Specifically, monitoring agents 245 of each subsystem may be configured to be capable of determining the workload of shared resources 255, and of reserving at least a portion of shared resources 255 that is to be employed by the reserving subsystem to process a request for content. For example, monitoring agent 245 of application RAM subsystem module 220 may be configured to monitor and reserve shared resource 255, such as RAM, for use by streaming application on a per-stream basis as well as for use with connection control structures and buffers.

In addition to deterministic interaction between individual subsystem modules of FIG. 2, communications (e.g., IPC protocol) and data movement between the modules may also be deterministic. In this regard, control messaging and data movement between subsystems may be configured to exhibit deterministic characteristics, for example, by employing one or more distributive interconnects (e.g., switch fabrics) to support deterministic data delivery and communication across the range of delivered loads. In one embodiment, separate distributive interconnects may be employed, for example, to deterministically perform the separate respective functions of inter-process communications path 230 and inter-process data movement path 235 of FIG. 2. In another embodiment, these separate functions may be combined and together deterministically performed by a single distributive interconnect, such as a single distributive interconnect 1080 of FIG. 1A. In either case, a distributive interconnect may be configured to support the bandwidth of communications and/or data (e.g., content) being transmitted or served so that added latency is not incurred.

As shown in FIG. 2, a separate monitoring agent 245 may be employed for each distributive interconnect present in a given system, with each interconnect being treated as a separate subsystem module. For example, in the exemplary embodiment of FIG. 2, monitoring agent 245 of inter-process communication path 230 may be configured to monitor and reserve such resources as the bandwidth available for message passing between subsystems while monitoring agent 245 of inter-process data movement path 235 may be configured to monitor and reserve the bandwidth available for passing data between the various subsystems. In another example, multiple distributive interconnects may be provided with monitoring agents to monitor and reserve either communication or data movement flow paths on an assigned or as-needed basis between subsystem modules, or between other distributive interconnects (e.g., in the case of internally clustered systems). Alternatively, a monitoring agent of a single distributive interconnect may be configured to monitor and reserve message-passing and data-passing bandwidth when these functions are handled by a single distributive interconnect, such as a single switch fabric.

Still referring to FIG. 2, method 100 of FIG. 5 may be implemented by system 200 as follows. System 200 begins by waiting for a request at step 105. In this regard, networking subsystem module 205 or some other subsystem module of system 200 may receive a request for content or a request for services from source 260, or from any of the other possible sources previously mentioned. As previously described, a request for content may include such requests as a request to start a video stream, a request for stored data, etc. A request for services may include, for example, a request for a database query, a request for a process to start, a request for an application to be run, etc.

At step 110, system monitor 240 filters the request for content as previously described. In this capacity, system monitor 240 may be configured to coordinate deterministic actions of system 200 by acting as a central clearing house or evaluator of content requests, and by directing the disposition of same. Although described in relation to system monitor 240, it will be understood that coordination of deterministic tasks may be performed by any subsystem module or combination of subsystem modules suitable for performing one or more of the tasks described herein as being performed by system monitor 240. For example, filtering tasks may be performed in whole or in part by application processing subsystem module 225. Furthermore, it will also be understood that one or more deterministic coordination tasks may be performed by processors or combinations of processors that are integral and/or external to a given system 200. For example, a processing module (e.g., system monitor 240) integral to a single system 200 may perform the deterministic coordination tasks for a cluster of linked systems. In an alternate example, a separate dedicated external processing module may be employed to perform the deterministic coordination tasks for a single system 200, or a cluster of such systems.

Once a request has been filtered at step 110 and the resources 250 required to process the request have been identified at step 115, system monitor 240 proceeds to step 120 and polls all of the monitoring agents 245 of the subsystem modules having the resources 250 that have been identified as being required to interact to process the given request, and accumulates responses from monitoring agents 245 at step 125. In response to this polling, a given subsystem module may be configured to refuse to take on additional requests unless it currently has, or will have within a specified period of time, the resources 250 available to process the new request without degradation to requests that it is already processing.

The monitoring tasks of monitoring agents 245 may be performed by any processor or combination of processors suitable for performing one or more of the monitoring tasks as described elsewhere herein. In this regard, monitoring tasks may be performed by one or more processors integral to a given monitored subsystem module as illustrated in FIG. 2, or may alternatively be performed by one or more processors external to the given subsystem module, or even external to system 200 itself. Furthermore, it is possible that a combination of monitoring tasks and deterministic coordination tasks may be performed by the same individual processor (e.g., both functions performed by system monitor 240), or by a combination of processors. Thus, it will be understood that the disclosed methods and systems may be implemented using a wide variety of hardware and/or logical configurations suitable for achieving the deterministic management of information as described herein.

After the responses from monitoring agents 245 are accumulated in step 125, system monitor 240 evaluates the responses at step 135 to determine if adequate resources are available as previously described, although evaluation may be accomplished in any other suitable manner, such as by using a different processing module or a combination of processing modules. For example, application processing subsystem module 225 may communicate with system monitor 240 and evaluate responses based on the resource responses or notifications that have been accumulated by system monitor 240 in step 125.

As previously mentioned, system monitor 240 may then participate in reserving and queuing the resources of each subsystem at steps 140 and 145 if the monitoring agents 245 of the appropriate subsystems have indicated that they have the identified resources 250 available that are required to process the request. Alternatively, individual monitoring agents 245 may reserve the required resources based upon requirements communicated to monitoring agents 245 by system monitor 240 or other processing module/s. An individual processing queue for each subsystem module may be maintained by its appropriate monitoring agent, and/or a centralized processing queue may be maintained for one or more modules by the system monitor.

As previously mentioned with respect to step 150, disposition of requests that a information management system is immediately unable to process or will not be able to process within a specified period of time may be determined by consulting one or more handling policies. For example, a request for content may be rejected in step 160, re-directed to another server 201 with capacity to spare in step 155, or queued for later processing in step 165. As with other exemplary steps of method 100, handling policy evaluation step 150 may be performed by system monitor 240, and/or other suitable processing module/s (e.g., application processing subsystem module 225).

The disclosed methods of deterministic information management may be accomplished using a variety of control schemes. For example, in one embodiment an application itself (e.g., video streaming) may be configured to have intimate knowledge of the underlying hardware/resources it intends to employ so as to enable identification, evaluation and reservation of required hardware/resources. However, in another embodiment the operating system employed by an information management system may advantageously be configured to maintain the necessary knowledge of the information management system hardware and hide such details from the application. In one possible embodiment, such an approach may be implemented for more general deployment in the following manner. An operating system vendor or a standards body may define a set of utilization metrics that subsystem vendors would be required to support. Monitoring and reservation of these resources could then be ‘built-in’ to the operating system for application developers to use. As one specific example, network interface card vendors might be required to maintain percent utilization of inbound and outbound bandwidth. Thus, if a request is received by a content delivery system for delivery of an additional 300 kb/s (kilobit per second) video stream, and the outbound networking path is already 99% utilized, such a request for content may be rejected.

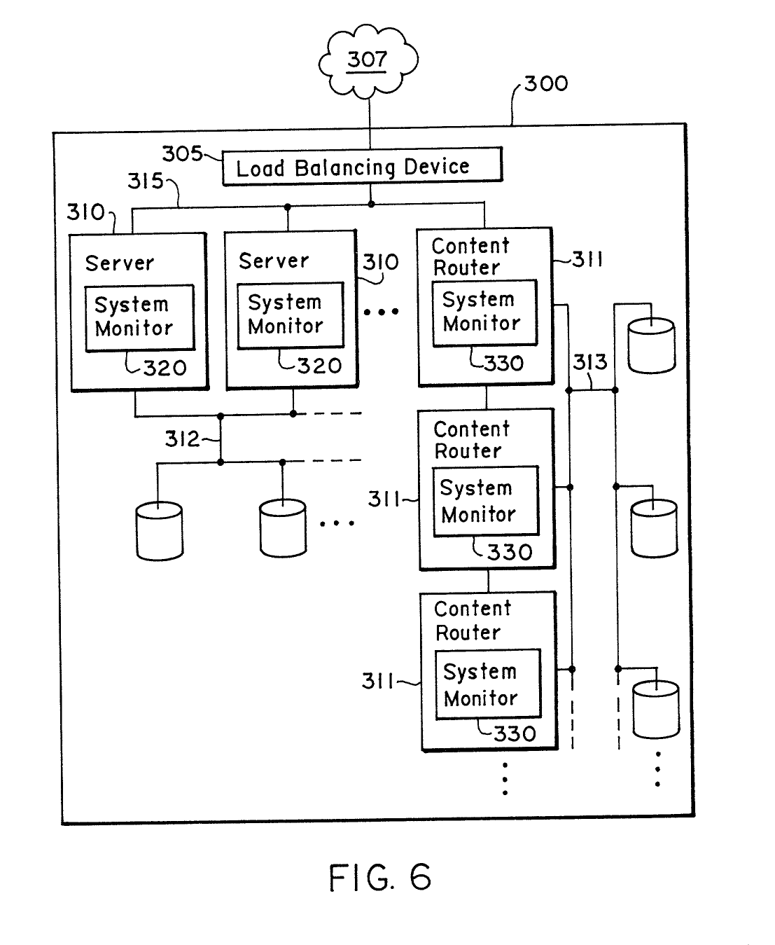

Deterministic management of information has been described herein in relation to particular system embodiments implemented with multiple subsystem modules distributively interconnected in a single chassis system, or in relation to embodiments including a cluster of such systems. However, it will be understood that information may be deterministically managed using a variety of different hardware and/or software types and may be implemented on a variety of different scales. FIG. 6 illustrates just one example of such an alternate embodiment in which the concept of a series of distributively interconnected subsystems may be extrapolated from optimization of resources within a single chassis information management system (e.g., server, router, etc.) to optimization of server resources in a data center 300. Such an implementation may involve deterministically managing communications and information flow between a number of separate devices within data center 300, although it may also be implemented to deterministically manage communication and information flow between similar-type devices integrated into the same chassis.

As shown in FIG. 6, data center 300 may include a device or blade, such as load balancing device 305, that is responsible for load-balancing traffic requests received from network 307 across a number of servers 310 and/or content routers 311 (e.g. within the same chassis or a number of chassis), and in which load-balancing device 305 communicates with servers 310 and/or content routers 311 over a distributively interconnected control/data path 315. In such an embodiment, load balancing device 305 may communicate with system monitors 320 and 330 of respective servers 310 and content routers 311 to determine whether servers 310 or content routers 311 have resources available. Such resources may include, for example, available bandwidth of storage area networks 312 and/or 313 to handle additional requests. In this regard, load balancing device 305 may filter and evaluate requests, poll data center 300 resources, evaluate the responses and dispose of the requests in a deterministic manner similar to that described elsewhere herein, e.g., for system monitor 240 of FIG. 2.

In a further possible embodiment, one or more of servers 310 and/or content routers 311 may be internally configured with subsystem modules that are distributively interconnected and deterministically managed, for example, in a manner as described in relation to FIGS. 1A and 2. In such an implementation, each server 310 and content router 311 itself (in terms of delivering streams or pages) is capable of monitoring its resources and interacting with an external agent in a way that is analogous to the way that the internal subsystems of individual servers 310 and/or content routers 311 are interacting.

In other further embodiments, the disclosed deterministic information management concept may be applied to many different technologies where the concept of a server may be generalized. For example, implementation of the present invention may apply to a device that routes data between a gigabit Ethernet connection to a Fiber Channel connection. In such an implementation, the subsystems may be a networking subsystem, a Fiber Channel subsystem and a routing subsystem. An incoming request for a SCSI (Small Computer System Interface) block would appear at the networking subsystem. The system monitor would then poll the system devices to determine if resources are available to process the request. If not, the request is rejected, or else the necessary resources are reserved and the request is subsequently processed.

Finally, although various embodiments described herein disclose monitoring each individual processing engine of an information management system, such as each subsystem module of content delivery system 200 of FIG. 2, such extensive monitoring may not be necessary in particular application environments. For example, if one or more processing engines has sufficient resources to handle virtually any workload that the information management system is able to provide, it may be unnecessary to track the availability of those resources. In such an implementation, the processing power that may have been utilized to monitor, poll, track, etc. the resources of such a processing engine may be conserved or eliminated. Such a reduction in monitoring and processing power may reduce the overall system cost as well as reduce system design costs.

It will be understood with benefit of this disclosure that although specific exemplary embodiments of hardware and software have been described herein, other combinations of hardware and/or software may be employed to achieve one or more features of the disclosed systems and methods. For example, various and differing hardware platform configurations may be built to support one or more aspects of deterministic functionality described herein including, but not limited to other combinations of defined and monitored subsystems, as well as other types of distributive interconnection technologies to interface between components and subsystems for control and data flow. Furthermore, it will be understood that operating environment and application code may be modified as necessary to implement one or more aspects of the disclosed technology, and that the disclosed systems and methods may be implemented using other hardware models as well as in environments where the application and operating system code may be controlled.

Thus, while the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus and methods may be utilized in various combinations and/or independently. Thus the invention is not limited to only those combinations shown herein, but rather may include other combinations.

What is claimed is:

1. A method for controlling delivery of requested content by a system having resources capable of delivering the content, the method comprising:
receiving a request for content;
polling the resources required to process the request for content to determine whether the resources are available to process the request for content; and
reserving the resources available to process the request for content.

2. The method of claim 1 further comprising evaluating the request for content to identify the resources required to process the request for content.

3. The method of claim 1 further comprising:
compiling responses received from the polled resources which indicate availability of the resources to process the request; and
evaluating the responses to determine whether the request for content can be processed.

4. The method of claim 1 further comprising queuing the request for content for processing by the reserved resources.

5. The method of claim 1 further comprising:
communicating with at least one monitoring agent operably coupled to the resources, the monitoring agent operable to determine a current workload of the resources;
evaluating the current workload of the resources to determine whether the required resources are available to process the request for content; and
generating a response indicative of the availability of the required resources based on the current workload.

6. The method of claim 1 further comprising evaluating one or more handling policies to determine the disposition of the request for content.

7. The method of claim 6 wherein disposition comprises queuing the request for content for processing.

8. The method of claim 6 wherein disposition comprises transferring the request for content to another system for processing.

9. The method of claim 6 wherein disposition comprises rejecting the request for content.

10. The method of claim 6 wherein disposition comprises rejecting the request for content if the request for content cannot be processed within a specified period of time.

11. The method of claim 1 further comprising:
polling at least one shared resource required to process the request for content; and
reserving any available shared resource required to processing the request for content.

12. A deterministic delivery system comprising:
a plurality of subsystems, each subsystem including at least one resource operable to process a portion of a request;
a system monitor operably coupled to the plurality of subsystems; and
the system monitor operable to receive a request to be processed, to poll at least one of the plurality of subsystems to determine whether resources required to process the request are available and to reserve the available resources required to process the request.

13. The system of claim 12 further comprising the system monitor operable to identify the resources required to process the request.

14. The system of claim 12 further comprising:
a monitoring agent operably coupled to each of the plurality of subsystems; and
the monitoring agents operable to determine whether the at least one resource operable to process the request is available.

15. The system of claim 14 further comprising:
one or more shared resources operably coupled to the plurality of subsystems; and
at least one monitoring agent operable to poll the one or more shared resources shared to determine whether the shared resources are available to process the request and to reserve the available shared resources.

16. The system of claim 15 further comprising the monitoring agent operable to reserve the at least one resource operable to process the request.

17. The system of claim 12 further comprising:
a communications path operably coupling the system monitor and one or more of the plurality of subsystems; and
a monitoring agent operably coupled to the communications path, the monitoring agent operable to evaluate a workload of the communications path and to reserve at least a portion of the communications path for processing the request.

18. The system of claim 12 further comprising:
a data movement path operably coupled to the plurality of subsystems; and
the data movement path operable to move data associated with the request between one or more of the plurality of subsystems.

19. The system of claim 12 further comprising the system monitor operable to evaluate one or more handling policies to determine proper disposition of the request.

20. The system of claim 19 further comprising at least one of the one or more system policies operable to instruct the system monitor to reject the request for content when the request for content cannot be processed within a specified time period.

21. The system of claim 12 further comprising the plurality of subsystems including data center components.

22. The system of claim 12 further comprising the plurality of subsystems including components of a computing device.

23. A system for processing requests for content comprising:
a communications path;
a plurality of subsystems operably coupled to the communications path, each of the plurality of subsystems having one or more resources operable to process at least a portion of a request for content;
a monitoring agent operably coupled to each of the plurality of subsystems, each monitoring agent operable to monitor the one or more resources of each subsystem and to reserve at least a portion of the resources of each subsystem; and
a system monitor operably coupled to the communications path, the system monitor operable to receive the request for content, to identify the resources required to process the request for content, to poll the monitoring agents of the subsystems having the resources required to process the request, to determine whether the resources required are available to process the request for content and to direct the monitoring agents operably coupled to the resources required to process the request for content to reserve the available resources required to process the request for content.

24. The system of claim 23 further comprising:
a data movement path operably coupled to the system monitor and the plurality of subsystems; and
the data movement path operable to move data associated with the request for content between at least a portion of the plurality of subsystems.

25. The system of claim 23 further comprising one or more shared resources operably coupled to one or more of the plurality of subsystems.

26. The system of claim 25 further comprising:
at least one monitoring agent of the one or more subsystems operably coupled to the one or more shared resources; and
the monitoring agent operable to determine whether the one or more shared resources are available to process the request for content and to reserve at least a portion of the one or more shared resources available to process the request for content.

27. The system of claim 23 further comprising the monitoring agents operable to determine a current workload of the resources required to process the request for content and to notify the system monitor of the availability of the resources required to process the request for content based on the current workload of the resources required.

28. The system of claim 23 further comprising the system monitor operable to evaluate one or more handling policies to determine disposition of the request for content.

29. The system of claim 28 further comprising at least one of the one or more handling policies operable to direct the system monitor to dispose of the request for content when the request for content cannot be processed within a specified period of time.

30. A method for processing a request for content comprising:
receiving a request for content;
identifying one or more subsystems having resources required to process the request for content;
polling the one or more subsystems to determine whether the resources required are available to process the request for content;
evaluating responses received from the one or more subsystems based on availability of the resources required to process the request; and
disposing the request for content based on the evaluation of the responses.

31. The method of claim 30 further comprising:
reserving at least a portion of the available resources required to process the request for content; and
queuing the request for content for processing by the reserved resources.

32. The method of claim 30 further comprising queuing the request for content for reevaluation of resource availability.

33. The method of claim 30 further comprising transferring the request for content to a system having resources available to process the request for content available.

34. The method of claim 30 further comprising rejecting the request for content.

35. The method of claim 30 further comprising:
determining availability of the resources required to process the request for content; and
generating a response indicative of the availability of the resources required.

36. The method of claim 30 further comprising:
polling one or more resources shared by the one or more subsystems to determine whether the shared resources are available to process the request for content; and
reserving the shared resources available to process the request.

37. The method of claim 30 wherein the request for content further comprises a request for data.

38. The method of claim 30 wherein the request for content further comprises a request for services.

39. The method of claim 30 further comprising rejecting the request for content when the request for content cannot be processed within a specified period of time.

40. A deterministic delivery system comprising:
a system monitor;
a plurality of subsystems operably coupled to the system monitor, each subsystem including at least one resource operable to process a portion of a request;
the plurality of subsystems operable to generate and transmit a notification to the system monitor indicative of whether the at least one resource of each subsystem is available take on additional processing; and
the system monitor operable to accumulate the notifications received from the subsystems, to receive a request to be processed, to evaluate the notifications received from the plurality of subsystems to determine whether resources required to process the request are available and to reserve the available resources required to process the request.

41. The system of claim 40 further comprising the system monitor operable to reject the request if the notifications received from the plurality of subsystems indicate that the resources required to process the request are unavailable.

42. The system of claim 40 further comprising the system monitor operable to accept the request if the notifications received from the plurality of subsystems indicate that the resources required to process the request are available.

43. The system of claim 40 further comprising the system monitor operable to identify the resources required to process the request.

44. The system of claim 40 further comprising:
a monitoring agent operably coupled to each of the plurality of subsystems; and
the monitoring agents operable to determine whether the at least one resource operable to process the request is available and to generate and transmit the notification indicative of whether the at least one resource is available.

45. The system of claim 44 further comprising:
one or more shared resources operably coupled to the plurality of subsystems; and
at least one monitoring agent operable to determine whether the shared resources are available to process the request and to reserve the available shared resources.

46. The system of claim 45 further comprising the monitoring agent operable to reserve the at least one shared resource operable to process the request.

47. The system of claim 40 further comprising:
a communications path operably coupling the system monitor and one or more of the plurality of subsystems; and
a monitoring agent operably coupled to the communications path, the monitoring agent operable to evaluate a workload of the communications path and to reserve at least a portion of the communications path for processing the request.

48. The system of claim 40 further comprising:
a data movement path operably coupled to the plurality of subsystems; and
the data movement path operable to move data associated with the request between one or more of the plurality of subsystems.

49. A method for controlling delivery of requested content by a system having resources capable of delivering the content, the method comprising:
receiving a request for content;
compiling notifications received from the resources which indicate availability of the resources to process the request; and
reserving the resources available to process the request for content.

50. The method of claim 49 further comprising evaluating the request for content to identify the resources required to process the request for content.

51. The method of claim 49 further comprising evaluating the notifications to determine whether the request for content can be processed.

52. The method of claim 49 further comprising queuing the request for content for processing by the reserved resources.

53. The method of claim 49 further comprising:
communicating with at least one monitoring agent operably coupled to the resources, the monitoring agent operable to determine a current workload of the resources;
evaluating the current workload of the resources to determine whether the required resources are available to process the request for content; and
generating a notification indicative of the availability of the required resources based on the current workload.

54. The method of claim 49 further comprising evaluating one or more handling policies to determine the disposition of the request for content.

55. The method of claim 54 wherein disposition comprises queuing the request for content for processing.

56. The method of claim 54 wherein disposition comprises transferring the request for content to another system for processing.

57. The method of claim 54 wherein disposition comprises rejecting the request for content.

58. The method of claim 49 further comprising:
polling at least one shared resource required to process the request for content; and
reserving any available shared resource required to processing the request for content.

59. A network connectable information management system, comprising:
a plurality of processing engines, said processing engines adapted to manipulate information; and
a system monitor in communication with said plurality of processing engines;
wherein said information management system is connected to a network; and
wherein said system monitor is configured to monitor a status of a parameter associated with at least one of said processing engines, and to manage manipulation of information in a deterministic manner based at least in part on a status of said parameter.

60. The system of claim 59, wherein said system comprises a network endpoint system; wherein said system monitor is configured to manage delivery of information to said network in a deterministic manner; and wherein one of said processing engines comprises a network processor.

61. The system of claim 60, wherein said network endpoint system is a content delivery system.

62. The system of claim 59, wherein said system comprises an intermediate node system; wherein said system monitor is configured to manage delivery of information to said network in a deterministic manner; and wherein one of said processing engines comprises a network processor.

63. The system of claim 62, wherein said intermediate node system is a network switch or network router.

64. The system of claim 59, wherein said plurality of processing engines and said system monitor communicate as peers in a peer to peer environment.

65. The system of claim 59, further comprising a distributed interconnect coupled to each of said processing engines and said system monitor.

66. The system of claim 65, wherein said distributed interconnect comprises a switch fabric.

67. The system of claim 59, wherein each of said plurality of processing engines is assigned separate information manipulation tasks in an asymmetrical multi-processor configuration.

68. The system of claim 67, wherein said plurality of processing engines include a processing engine that couples said system to said network.

69. The system of claim 67, wherein said plurality of processing engines comprise a network interface engine, a storage processing engine and an application processing engine.

70. The system of claim 69, wherein said plurality of processing engines further comprise a system management engine.

71. The system of claim 69, wherein said system monitor comprises a system management engine.

72. A network connectable information management system, comprising:
a plurality of processing engines, said processing engines adapted to manipulate information; and
a system monitor in communication with said plurality of processing engines;
wherein said plurality of processing engines and said system monitor communicate as peers in a peer to peer environment;
wherein said information management system is adapted to deliver information to a network; and
wherein said system monitor is configured to monitor a status of a parameter associated with at least one of said processing engines, and to manage delivery of information to said network in a deterministic manner based at least in part on a status of said parameter.

73. The system of claim 72, wherein said system monitor is adapted to monitor a status of a parameter associated with one or more of said individual processing engines, said status of each processing engine comprising current or future availability of resources for performing an information manipulation task by said processing engine.

74. The system of claim 73, one or more of said processing engines comprises a subsystem module that includes a monitoring agent and said resources for performing an information manipulation task by said processing engine; said monitoring agent being adapted to monitor availability of said resources and to communicate said availability to said system monitor.

75. The system of claim 72, wherein said system monitor is adapted to manage delivery of said information in a deterministic manner by rejecting a request for information delivery to said network, by transferring a request for information delivery to another information management system connected to said system in a cluster, by re-queuing a request for information delivery for later reconsideration by said system, or a combination thereof.

76. The system of claim 72, wherein said system monitor is adapted to manage delivery of said information in a deterministic manner by selecting one or more of said processing engines to perform manipulation of information as required to effect said delivery of information.

77. The system of claim 76, wherein at least one of said processing engines is assignable to perform multiple information manipulation tasks; and wherein said system monitor is adapted to manage delivery of said information in a deterministic manner by assigning an information manipulation task to said processing engine as required to effect said delivery of information.

78. The system of claim 72, wherein said system monitor is adapted to manage delivery of said information in a deterministic manner by selecting one or more processing engines of another information management system connected to said system in a cluster to perform manipulation of information as required to effect said delivery of information.

79. The system of claim 72, wherein said system monitor is adapted to manage delivery of said information in a deterministic manner based at least in part on a parameter associated with a request for delivery of said information to said network.

80. The system of claim 79, wherein said parameter associated with a request comprises priority information associated with said request.

81. The system of claim 72, wherein said deterministic management enables accelerated system performance.

82. The system of claim 72, wherein said information comprises continuous content.

83. A method of managing information in a network connectable information management system, comprising:
monitoring a status of a parameter associated with at least one of a plurality of processing engines adapted to manipulate information in an information management system, said information management system being connected to a network; and
managing manipulation of information in a deterministic manner based at least in part on a status of said parameter.

84. The method of claim 83, wherein said information management system comprises a network endpoint system, and wherein one of said processing engines comprises a network processor.

85. The method of claim 84, wherein said network endpoint system is a content delivery system.

86. The method of claim 83, wherein said system comprises an intermediate node system, and wherein one of said processing engines comprises a network processor.

87. The method of claim 86, wherein said intermediate node system is a network switch or network router.

88. The method of claim 83, wherein said plurality of processing engines communicate as peers in a peer to peer environment.

89. The method of claim 83, wherein said plurality of processing engines are coupled together with a distributed interconnect.

90. The method of claim 89, wherein said distributed interconnect comprises a switch fabric.

91. The method of claim 83, wherein each of said plurality of processing engines is assigned separate information manipulation tasks in an asymmetrical multi-processor configuration.

92. The method of claim 91, wherein said plurality of processing engines include a processing engine that couples said system to said network.

93. The method of claim 91, wherein said plurality of processing engines comprise a network interface engine, a storage processing engine and an application processing engine.

94. The method of claim 93, wherein said plurality of processing engines further comprise a system management engine.

95. The method of claim 94, wherein said managing manipulation of information is performed at least in part by said system management engine.

96. The method of claim 95, wherein said manipulation of information comprises the delivery of information to said network.

97. The method of claim 96, wherein said delivery of information comprises delivery of continuous content to said network.

98. A method of managing information in a network connectable information management system, comprising:
monitoring a status of one or more individual processing engines adapted to manipulate information in an information management system, said information management system being connected to a network, said status of each processing engine comprising current or future availability of resources for performing an information manipulation task by said processing engine; and
managing manipulation of information in a deterministic manner based at least in part on a status of said resource availability.

99. The method of claim 98, wherein one or more of said processing engines comprises a subsystem module that includes a monitoring agent and the resources for performing an information manipulation task by said processing engine; wherein said monitoring agent is adapted to monitor and communicate availability of said resources; and wherein said method further comprises receiving a communication from said monitoring agent regarding availability of said resources.

100. The method of claim 98, wherein said method further comprises managing delivery of information to said network in a deterministic manner.

101. The method of claim 100, wherein said method further comprises managing delivery of information to said network by rejecting a request for information delivery to said network, transferring a request for information delivery to another information management system connected to said system in a cluster, re-queuing a request for information delivery for later reconsideration by said system, or a combination thereof.

102. The method of claim 100, wherein said method further comprises managing delivery of information to said network by selecting one or more of said processing engines to perform manipulation of information as required to effect said delivery of information.

103. The system of claim 102, wherein at least one of said processing engines is assignable to perform multiple information manipulation tasks; and wherein said method further comprises assigning an information manipulation task to said processing engine as required to effect said delivery of information.

104. The method of claim 100, wherein said method further comprises managing delivery of information to said network based at least in part on a parameter associated with a request for delivery of said information to said network.

105. The method of claim 104, wherein said parameter associated with a request comprises priority information associated with said request.

106. The method of claim 100, wherein said method further comprises managing delivery of information to said network based at least in part on future availability of resources for performing an information manipulation task by said processing engines.

107. The method of claim 106, wherein said method comprises monitoring the future availability of resources of multiple individual processing engines that are capable of performing the same information manipulation task, and selecting at least one of said multiple processing engines to perform said information manipulation task based on the relative future availability of resources of said multiple individual processing engines.

108. The method of claim 106, wherein said method further comprises managing delivery of information to said network based on the relative future availability of resources of said multiple individual processing engines by rejecting a request for information delivery to said network, transferring a request for information delivery to another information management system connected to said system in a cluster, re-queuing a request for information delivery for later reconsideration by said system, or a combination thereof.

109. The method of claim 100, wherein said information comprises continuous content.

110. A network connectable content delivery system, comprising:
a plurality of processing engines, said processing engines having one or more resources;
a network interface connection to at least one of the processor engines to couple the content delivery system to a network;
a system monitor in communication with said plurality of processing engines;
a distributed interconnect coupled to said processing engines to enable said processing engines and said system monitor to communicate as peers in a peer to peer environment;
wherein said system monitor is configured to monitor status of resources of said processing engines, and to manage delivery of content to said network by said system in a deterministic manner based at least in part on said status of said resources.

111. The system of claim 110, wherein said system comprises a network endpoint content delivery system, and wherein one of said processing engines comprises a network processor.

112. The system of claim 110, wherein said system comprises an intermediate node system that is a network switch or network router, and wherein one of said processing engines comprises a network processor.

113. The method of claim 110, wherein said processing engines comprise a network interface engine, an application processing engine, and a storage processor engine.

114. The system of claim 113, wherein said distributed interconnect comprises a switch fabric.

115. The system of claim 113, wherein said plurality of processing engines further comprise a system management engine.

116. The system of claim 113, wherein said system monitor comprises a system management engine coupled to said processing engines by said distributed interconnect.

117. The system of claim 113, wherein said system further comprises one or more shared resources coupled to said processing engines by said distributed interconnect, said system monitor being adapted to monitor use of said shared resources.

118. The system of claim 110, wherein said system monitor is adapted to monitor current or future availability of resources of said processing engines.

119. The system of claim 113, wherein one or more of said processing engines comprises a subsystem module that includes a monitoring agent and resources; said monitoring agent being adapted to monitor availability of said resources and to communicate said availability to said system monitor.

120. The system of claim 110, wherein said system monitor is adapted to manage delivery of said content in a deterministic manner by rejecting a request for content delivery to said network, by transferring a request for content delivery to another content delivery system connected to said system in a cluster by a distributed interconnect, by re-queuing a request for content delivery for later reconsideration by the current system, or a combination thereof.

121. The system of claim 110, wherein said system monitor is adapted to manage delivery of said content in a deterministic manner by selecting one or more of said processing engines to perform one or more tasks as required to effect said delivery of content.

122. The system of claim 121, wherein at least one of said processing engines is assignable to perform multiple tasks associated with content delivery; and wherein said system monitor is adapted to manage delivery of said content in a deterministic manner by assigning one or more of said multiple tasks to said processing engine to effect said delivery of content.

123. The system of claim 110, wherein said system monitor is adapted to manage delivery of said content in a deterministic manner by selecting one or more processing engines of another content management system connected to said system in a cluster via a distributed interconnect to perform one or more tasks as required to effect said delivery of content.

124. The system of claim 121, wherein said system monitor is adapted to deterministically manage delivery of said content to said network in response to a request for content by identifying processing engine resources necessary to process said request, evaluating availability of said resources, reserving said resources, and assigning one or more tasks to one or more of said processing engines having said resources as required to effect said delivery of content.

125. The system of claim 110, wherein said system monitor is adapted to manage delivery of said content in a deterministic manner based at least in part on a parameter associated with a request for delivery of said information to said network.

126. The system of claim 125, wherein said parameter associated with a request comprises priority information associated with said request.

127. The system of claim 110, wherein said system monitor is adapted to select one or more of said processing engines, to select one or more unique data flow paths between said processing engines, or a combination thereof as required to effect said delivery of content in a deterministic manner.

128. The system of claim 127, wherein said system monitor is adapted to select one or more of said processing engines, one or more unique data flow paths between said processing engines, or a combination thereof in response to failure of one or more system components.

129. The system of claim 127, wherein said system monitor is adapted to select one or more of said processing engines, one or more unique data flow paths between said processing engines, or a combination thereof based in response to a current or anticipated system data flow bottleneck.

130. The system of claim 110, wherein said system monitor is adapted to track usage of said resources on an individual client or individual request basis.

131. The system of claim 110, wherein said system monitor is adapted to anticipate future usage of said resources and to select individual processing engines, data flow paths between said processing engines, or a combination thereof based on said anticipated future usage to achieve accelerated system performance.

132. The system of claim 110, wherein said content comprises continuous content; and wherein said resources comprise available access to storage, available processor resources, available bandwidth to enable said content to be streamed from storage, or a combination thereof.

133. A method of delivering content to a network, comprising:
monitoring a status of resources associated with a plurality of processing engines in a content delivery system, said processing engines communicating as peers in a peer to peer environment via a distributed interconnect coupled to said processing engines; and
managing delivery of content to said network by said system in a deterministic manner based at least in part on said status of said resources.

134. The method of claim 133, wherein said content delivery system comprises a network endpoint system, and wherein one of said processing engines comprises a network processor.

135. The method of claim 133, wherein said system comprises an intermediate node system, and wherein one of said processing engines comprises a network processor.

136. The method of claim 133, wherein each of said plurality of processing engines is assigned separate information manipulation tasks in an asymmetrical multi-processor configuration.

137. The method of claim 136, wherein said plurality of processing engines include a network interface engine, a storage processing engine and an application processing engine.

138. The method of claim 133, wherein said distributed interconnect comprises a switch fabric.

139. The method of claim 133, wherein said monitoring comprises monitoring current or future availability of resources of said processing engines.

140. The method of claim 137, wherein one or more of said processing engines comprises a subsystem module that includes a monitoring agent and resources; said monitoring agent being adapted to monitor availability of said resources and to communicate said availability to said system monitor.

141. The method of claim 133, wherein said managing comprises rejecting a request for content delivery to said network, transferring a request for content delivery to another content delivery system connected to said system in a cluster by a distributed interconnect, requeuing a request for content delivery for later reconsideration by the current system, or a combination thereof.

142. The method of claim 133, wherein said managing comprises selecting one or more of said processing engines to perform one or more tasks as required to effect said delivery of content.

143. The method of claim 142, wherein at least one of said processing engines is assignable to perform multiple tasks associated with content delivery; and wherein said managing comprise assigning one or more of said multiple tasks to said processing engine to effect said delivery of content.

144. The method of claim 133, wherein said managing comprises selecting one or more processing engines of another content management system connected to said system in a cluster via a distributed interconnect to perform one or more tasks as required to effect said delivery of content.

145. The method of claim 142, wherein said managing comprises identifying processing engine resources necessary to process said request, evaluating availability of said resources, reserving said resources, and assigning one or more tasks to one or more of said processing engines having said resources as required to effect said delivery of content.

146. The method of claim 133, wherein said managing further comprises managing delivery of said content based at least in part on a parameter associated with a request for delivery of said content to said network.

147. The method of claim 146, wherein said parameter associated with a request comprises priority information associated with said request.

148. The method of claim 133, wherein said managing comprises selecting one or more of said processing engines, selecting one or more unique data flow paths between said processing engines, or a combination thereof as required to effect said delivery of content in a deterministic manner.

149. The method of claim 148, wherein managing comprises selecting one or more of said processing engines, one or more unique data flow paths between said processing engines, or a combination thereof in response to failure of one or more system components.

150. The method of claim 148, wherein said managing comprises selecting one or more of said processing engines, one or more unique data flow paths between said processing engines, or a combination thereof based in response to a current or anticipated system data flow bottleneck.

151. The method of claim 133, further comprising tracking usage of said resources on an individual client or individual request basis.

152. The method of claim 133, wherein said managing comprises anticipating future usage of said resources and selecting individual processing engines, data flow paths between said processing engines, or a combination thereof based on said anticipated future usage to achieve accelerated system performance.

153. The method of claim 133, wherein said content comprises continuous content; and wherein said resources comprise available access to storage, available processor resources, available bandwidth to enable said content to be streamed from storage, or a combination thereof.
